(19) United States
(12) Patent Application Publication
(10) Pub. No.: US 2025/0326241 A1
(43) Pub. Date: Oct. 23, 2025

(54) INKJET TEXTILE PRINTING METHOD, TREATMENT LIQUID FOR INKJET TEXTILE PRINTING, INK SET FOR INKJET TEXTILE PRINTING, AND INKJET TEXTILE PRINTING APPARATUS

(71) Applicant: Konica Minolta, Inc., Tokyo (JP)

(72) Inventor: Kenichi ONAKA, Tokyo (JP)

(21) Appl. No.: 19/173,917

(22) Filed: Apr. 9, 2025

(30) Foreign Application Priority Data
Apr. 23, 2024 (JP) 2024-069686

(51) Int. Cl. B41M 5/00; B41J 3/407; B41J 11/00; C09D 11/322; C09D 11/54; D06P 5/30

(52) U.S. Cl. CPC B41M 5/0017; B41J 3/4078; B41J 11/002; C09D 11/322; C09D 11/54; D06P 5/30

(57) ABSTRACT

Disclosed is an inkjet textile printing method with first treatment liquid containing flocculant and being for retaining at least one of pigment ink and second treatment liquid on a textile surface, the method including: arranging the inkjet heads that eject the first and second treatment liquids and pigment ink in a same carriage; forming an image by a multi-pass method; in a forward path, after applying the first treatment liquid, applying the pigment ink and the second treatment liquid in this order; in a return path, after applying the second treatment liquid, applying the pigment ink and the first treatment liquid in this order; and attaching the first and second treatment liquids and pigment ink to a same place in a same scanning in an undried state. The second treatment liquid contains silicone acrylic resin and first resin particles having film elongation of 600 to 1600%.

### CROSS-REFERENCE TO RELATED APPLICATIONS

The entire disclosure of Japanese Patent Application No. 2024-069686, filed on Apr. 23, 2024, is incorporated herein by reference in its entirety.

### BACKGROUND OF THE INVENTION

### Technical Field

The present invention relates to an inkjet textile printing method, a treatment liquid for inkjet textile printing, an ink set for inkjet textile printing, and an inkjet textile printing apparatus. In particular, the present invention relates to an inkjet textile printing method, a treatment liquid for inkjet textile printing, an ink set for inkjet textile printing, and an inkjet textile printing apparatus, all of which can form an image having satisfactory wet friction robustness on textile without degrading the texture.

### Description of Related Art

Conventionally, inkjet textile printing methods using inkjet recording apparatuses (printing apparatuses) have been used as methods for forming images such as letters, pictures, and patterns on textiles such as woven textiles and nonwoven textiles (see, for example, Japanese Unexamined Patent Publication No. 2022-3175 and Japanese Unexamined Patent Publication No. 2022-162288). In such an inkjet textile printing method, a method is usually common in which a pre-treatment liquid is used to aggregate a color material ink so that the ink retains on the surface of the textile, thereby improving the color density. Hereinafter, the “coloring material ink” used in the inkjet textile printing method is also referred to simply as “ink”.

In the inkjet textile printing method, improvement in productivity and improvement in color development stability can be expected by continuously performing the step of applying the pretreatment liquid and the step of applying and dyeing the ink. Furthermore, the pretreatment liquid is applied with an inkjet head and the inkjet head is arranged in the same carriage as the inkjet head for ink ejection, which is advantageous in that the pretreatment liquid can be applied only to a portion of an image printed area where the pretreatment liquid is needed and that the size can be reduced. For example, Japanese Unexamined Patent Publication No. 2022-162288 discloses an inkjet textile printing method in which an inkjet head that ejects a treatment liquid and an inkjet head that ejects ink are arranged in the same carriage, and an image is formed by a multi-pass method.

Incidentally, in a multi-pass method in which a head carriage moves, in order to reduce individual differences of heads, it is common to perform pass separation of an image and perform image formation by reciprocating a plurality of times in a lateral direction with respect to a conveyance direction of a textile To be printed. Hereinafter, the multi-pass method in which the head carriage moves is also referred to as a “scanning method”.

### SUMMARY OF THE INVENTION

However, in a case where the treatment liquid such as the above-described pretreatment liquid and the ink are placed in the same carriage, the applying order of the treatment liquid and the ink is reversed by the reciprocating operation of the carriage. Therefore, there arises a problem that the concentration on the front surface or the concentration on the back surface of the textile is changed between a case where the ink is applied after the treatment liquid is applied and a case where the treatment liquid is applied after the ink is applied.

In order to improve this, a structure in which heads for the treatment liquid are arranged on both sides of the carriage and the like have been considered. Here, in a case where the heads for the treatment liquids are arranged on both sides of the carriage, in consideration of printing speed and downsizing of the apparatus, it is desirable that the heads are arranged in the same row in the order of the first treatment liquid, the pigment ink, and the second treatment liquid in the same carriage. For example, in the forward path of the carriage, the ejection order is the first treatment liquid, the pigment ink, and the second treatment liquid. For this reason, in the forward path, when the first treatment liquid includes the flocculant, it is possible to suppress the penetration of the resin or the pigment in the ejecting direction (hereinafter, also referred to as “Z direction”) of the ink by the inkjet head. On the other hand, since the pigment ink or the first treatment liquid is ejected after the second treatment liquid which does not include the flocculant in the return path, there is a problem in that the penetration of the resin or the pigment in the Z direction of the textile increases and the texture is damaged.

The present invention has been conceived in consideration of the above. A problem to be solved by the present invention is to provide an inkjet textile printing method capable of forming an image having satisfactory wet friction robustness on a textile without degrading the texture. In addition, the problem to be solved by the present invention is to provide a treatment liquid for inkjet textile printing used in the above-described inkjet textile printing method, an ink set for inkjet textile printing using the same, and an inkjet textile printing apparatus.

In order to solve the above-described problem, the present inventors have conducted intensive studies focusing on the component of the second treatment liquid to be ejected first in the return path in the multi-pass method. As a result, the present inventors have found that even when the second treatment liquid does not contain a flocculant, by containing resin particles having a specific film elongation and a silicone acrylic resin in the second treatment liquid, good texture can be maintained even in the applying order such as the above-described return path, and thus the present invention has been achieved.

To achieve at least one of the abovementioned objects, according to one aspect of the present invention, inkjet textile printing method reflecting one aspect of the present invention is an inkjet textile printing method for applying a pigment ink, a first treatment liquid, and a second treatment liquid with an inkjet head, the first treatment liquid containing a flocculant and being for retaining at least one of the pigment ink and the second treatment liquid on a textile surface, the method comprising:
arranging the inkjet head that ejects the first treatment liquid, the inkjet head that ejects the pigment ink, and the inkjet head that ejects the second treatment liquid in a same carriage;
forming an image by a multi-pass method;
in a forward path, after applying of the first treatment liquid, applying the pigment ink and the second treatment liquid in an order of the pigment ink and the second treatment liquid;
in a return path, after applying of the second treatment liquid, applying the pigment ink and the first treatment liquid in an order of the pigment ink and the first treatment liquid,
wherein the second treatment liquid contains a silicone acrylic resin and first resin particles having a film elongation of 600 to 1600%; and
attaching the first treatment liquid, the pigment ink, and the second treatment liquid to a same place in a same scanning in an undried state.

To achieve at least one of the abovementioned objects, according to another aspect of the present invention, treatment liquid for inkjet textile printing reflecting one aspect of the present invention is a treatment liquid for inkjet textile printing as a second treatment liquid used in the inkjet textile printing in which a pigment ink, a first treatment liquid, and the second treatment liquid are applied with an inkjet head, wherein
the first treatment liquid contains a flocculant and is for retaining the pigment ink or the second treatment liquid on a textile surface,
the inkjet head that ejects the first treatment liquid, the inkjet head that ejects the pigment ink, and the inkjet head that ejects the second treatment liquid are arranged in a same carriage and are used to form an image by a multi-pass method,
in a forward path, after applying of the first treatment liquid, the pigment ink and the second treatment liquid are applied in an order of the pigment ink and the second treatment liquid,
in a return path, after applying of the second treatment liquid, the pigment ink and the first treatment liquid are applied in an order of the pigment ink and the first treatment liquid,
the second treatment liquid contains a silicone acrylic resin and first resin particles having a film elongation of 600 to 1600%, and
the first treatment liquid, the pigment ink, and the second treatment liquid are attached to a same place in a same scanning in an undried state.

To achieve at least one of the abovementioned objects, according to another aspect of the present invention, ink set for inkjet textile printing reflecting one aspect of the present invention is an ink set for inkjet textile printing comprising pigment ink, a first treatment liquid, and a second treatment liquid, wherein
the second treatment liquid is the above-described treatment liquid for inkjet textile printing.

To achieve at least one of the abovementioned objects, according to another aspect of the present invention, inkjet textile printing apparatus reflecting one aspect of the present invention is an inkjet textile printing apparatus comprising an inkjet head to apply a pigment ink, a first treatment liquid, and a second treatment liquid, wherein
the first treatment liquid contains a flocculant and is for retaining the pigment ink or the second treatment liquid on a textile surface,
the inkjet head that ejects the first treatment liquid, the inkjet head that ejects the pigment ink, and the inkjet head that ejects the second treatment liquid are arranged in a same carriage,
an image is formed by a multi-pass method,
in a forward path, after applying of the first treatment liquid, the pigment ink and the second treatment liquid are applied in an order of the pigment ink and the second treatment liquid,
in a return path, after applying of the second treatment liquid, the pigment ink and the first treatment liquid are applied in an order of the pigment ink and the first treatment liquid,
the second treatment liquid contains a silicone acrylic resin and first resin particles having a film elongation of 600 to 1600%, and
the first treatment liquid, the pigment ink, and the second treatment liquid are attached to a same place in a same scanning in an undried state.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic view schematically showing an embodiment of an inkjet textile printing apparatus;

FIG. 2 is a schematic diagram schematically showing an example of a main part of a multi-pass inkjet applying apparatus;

FIG. 3 is a flowchart illustrating an example of steps of applying a treatment liquid and a pigment ink in a multi-pass method; and

FIG. 4 is a diagram illustrating a schematic configuration of an inkjet textile printing apparatus in which a textile is attached to a conveyance belt to be conveyed.

### DETAILED DESCRIPTION

One embodiment of the inkjet textile printing method of the present invention is an inkjet textile printing method in which a pigment ink, a first treatment liquid, and a second treatment liquid are applied with an inkjet head. Hereinafter, the inkjet textile printing method of the present embodiment is also simply referred to as a “textile printing method”. However, the scope of the invention is not limited to the disclosed embodiments.

In the textile printing method of the present embodiment, the inkjet head that ejects the first treatment liquid, the inkjet head that ejects the pigment ink, and the inkjet head that ejects the second treatment liquid are arranged in the same carriage, and an image is formed by a multi-pass method. Next, in the forward path of the multi-pass method, after the first treatment liquid is applied, the pigment ink and the second treatment liquid are applied in this order. On the other hand, in the return path of the multi-pass method, after the second treatment liquid is applied, the pigment ink and the first treatment liquid are applied in this order. The first treatment liquid that is ejected first in the forward path contains a flocculant. The first treatment liquid is for retaining at least one of a pigment ink and the second treatment liquid on the surface of textile. The second treatment liquid that is injected first in the return path contains the silicone acrylic resin and first resin particles having a film elongation of 600 to 1600%. The textile printing method of the present embodiment is characterized in that the first treatment liquid, the pigment ink, and the second treatment liquid are attached in an undried state to the same place in the same scanning (in other words, the main scanning of the ink ejection device) by the forward path and the return path of the multi-pass method as described above. The above-described features are technical features common to or corresponding to the following embodiments.

According to the textile printing method of the present embodiment, an image having good wet friction robustness can be formed on a textile without impairing the texture. That is, on the forward path, after the first treatment liquid is applied, the pigment ink and the second treatment liquid are sequentially applied, so that resins, pigments, and the like in the pigment ink and the second treatment liquid can be aggregated by the flocculant, thus effectively suppressing the penetration of the textile in the Z direction. Therefore, the pigment ink and the second treatment liquid are more likely to stay on the surface of the textile, the textile is less likely to become hard, and it is possible to maintain a satisfactory texture. On the other hand, the second treatment liquid that is ejected first onto the textile on the return path contains the silicone acrylic resin and first resin particles having a film elongation of 600 to 1600%. Since the first resin particles having a film elongation of 600 to 1600% are relatively soft resin particles, even when the first resin particles penetrate into the textile in the Z direction, the influence on the texture is small, and the texture of the textile can be maintained. In addition, for example, since the silicone acrylic resin assists wetting and spreading in the X direction and the Y direction, it is possible to suppress infiltration in the Z direction. Therefore, the silicone acrylic resin contained in the second treatment liquid also contributes to the maintenance of the texture of the textile. Furthermore, since the first treatment liquid that is finally ejected onto textile on the return path contains a flocculant, wet friction robustness is also maintained by such a first treatment liquid being finally ejected.

In the textile printing method of the present embodiment, the pigment ink preferably contains the second resin particles and an aqueous solvent. It is preferable that least one of the resins of the first resin particles of the second treatment liquid and the second resin particles of the pigment ink include an acrylic resin or a urethane resin. Such a configuration is advantageous in that, due to the properties of the resin, the nonwoven textile has good flexibility and the texture of the textile is more easily maintained.

In the textile printing method of the present embodiment, the pigment ink preferably contains a silicone acrylic resin. Such a configuration is advantageous in that the nonwoven textile is easy to wet and spread in the XY directions and restraint in the Z direction is suppressed, thus having satisfactory flexibility and further easily maintaining the texture of the textile.

In the textile printing method of the present embodiment, the first treatment liquid preferably contains at least one selected from the group consisting of a compound having a cationic group, a polyvalent metal salt, and an organic acid. The compound having a cationic group is more preferably a cationic resin. Such a constitution is advantageous in that it can interact or react with the anionic block copolymer which is a pigment dispersant contained in the pigment ink.

In the textile printing method of the present embodiment, the pigment ink preferably contains a pigment and a block copolymer. The block copolymer preferably contains two hydrophilic blocks A arranged at both ends of the molecule and a hydrophobic block B arranged between the two hydrophilic blocks A. Note that the hydrophilic block A interacts or reacts with at least the flocculant contained in the first treatment liquid. The block copolymer contained in the pigment ink more preferably contains an ABA-type block copolymer consisting of two hydrophilic blocks A and one hydrophobic block B. According to such a constitution, the pigment ink has good ejection stability, and an image having good wet friction robustness can be formed on a textile.

The pigment ink preferably contains a crosslinking agent. Such a configuration is advantageous in that, in a case where the pigment ink or the textile includes a (meth) acrylic resin having a crosslinkable group, a urethane resin, or the like, these react with the crosslinking agent to be post-crosslinked, thereby achieving suppression of the stickiness of the surface of the textile or excellent wet friction robustness.

Next, one embodiment of the treatment liquid for inkjet textile printing of the present invention will be described. The treatment liquid for inkjet textile printing of the present embodiment is a treatment liquid for inkjet textile printing as a second treatment liquid used in inkjet textile printing in which a pigment ink, a first treatment liquid, and a second treatment liquid are applied with an inkjet head. That is, the treatment liquid for inkjet textile printing of the embodiment is configured in the same manner as the second treatment liquid used in the textile printing method of the embodiment described above. Furthermore, one embodiment of the ink set for inkjet textile printing according to the present invention is an ink set for inkjet textile printing including a pigment ink, a first treatment liquid, and a second treatment liquid, wherein the second treatment liquid is the above-described treatment liquid for inkjet textile printing according to the present embodiment. According to such a treatment liquid for inkjet textile printing and an ink set for inkjet textile printing, an image having good wet friction robustness can be formed on a textile without impairing the texture.

Next, one embodiment of the inkjet textile printing apparatus of the present invention is described. Hereinafter, the inkjet textile printing method of the present embodiment is also simply referred to as a “textile printing method”. The textile printing apparatus of the present embodiment is an inkjet textile printing apparatus that applies a pigment ink, a first treatment liquid, and a second treatment liquid with inkjet heads. The first treatment liquid contains a flocculant and is for retaining a pigment ink or the second treatment liquid on the surface of textile. In the textile printing apparatus of the present embodiment, the inkjet head that ejects the first treatment liquid, the inkjet head that ejects the pigment ink, and the inkjet head that ejects the second treatment liquid are arranged in the same carriage. Then, the textile printing apparatus of the present embodiment forms an image by a multi-pass method. In the forward path of the multi-pass method, after the first treatment liquid is applied, the pigment ink and the second treatment liquid are applied in this order. On the other hand, in the return path of the multi-pass method, after the second treatment liquid is applied, the pigment ink and the first treatment liquid are applied in this order. The second treatment liquid contains the silicone acrylic resin and first resin particles having a film elongation of 600 to 1600%. The textile printing apparatus of the present embodiment is characterized in that the first treatment liquid, the pigment ink, and the second treatment liquid as described above are attached in an undried state to the same place in the same scanning (i.e., main scanning).

Hereinafter, the present invention, constituent elements thereof, and forms and aspects for carrying out the present invention will be described in detail. In the present application, “to” representing a numerical range is used to mean that numerical values described before and after “to” are included as a lower limit value and an upper limit value.

### [Inkjet Textile Printing Apparatus]

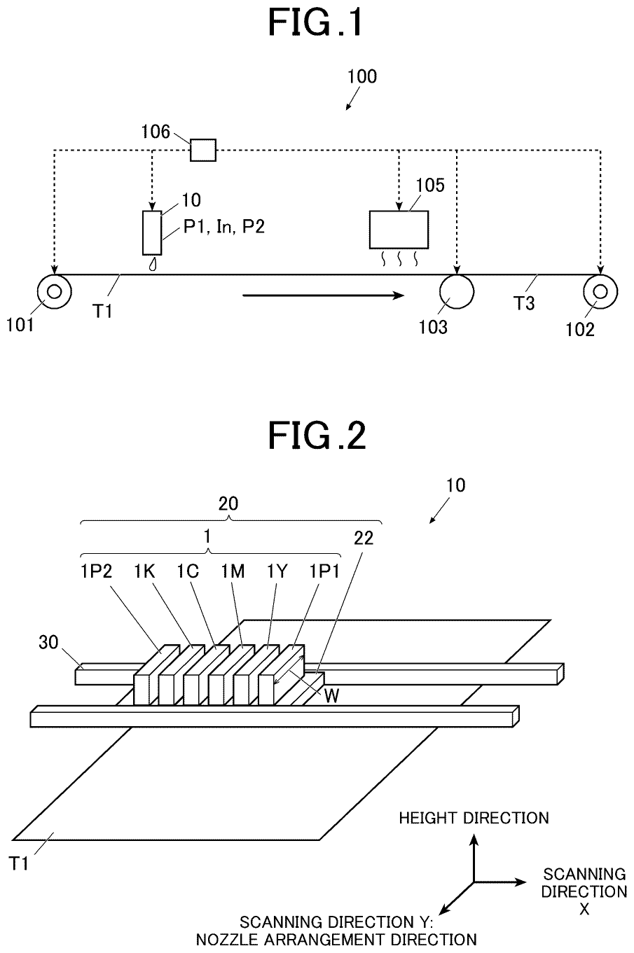

Hereinafter, an embodiment of the inkjet textile printing apparatus of the present invention will be described with reference to the drawings, but the present invention is not limited thereto. FIG. 1 is a schematic diagram schematically illustrating an embodiment of an inkjet textile printing apparatus of the present invention.

As illustrated in FIG. 1, the inkjet textile printing apparatus 100 includes a textile feeding section 101, a conveyance section 103, an applying section 10, a drying section 105, and a textile collection section 102. Hereinafter, the inkjet textile printing apparatus is also simply referred to as a “textile printing apparatus”. The textile feeding section 101 is for feeding out textile T1. The conveyance section 103 is for conveying the textile T1 fed from the textile feeding section 101. The applying section 10 is for applying the first treatment liquid P1, the pigmented ink In, and the second treatment liquid P2 to the textile T1. The drying section 105 is for drying the first treatment liquid P1, the pigmented ink In, the second treatment liquid, and the like. The textile collection section 102 is for collecting printed textile T3. Hereinafter, the printed textile T3 is also referred to as “printed textile T3”. In addition, the textile printing apparatus 100 further includes a controller 106 or the like which controls each member.

Furthermore, in the printing apparatus 100, the applying section 10 includes a first treatment liquid head to eject the first treatment liquid P1, a pigmented ink head to eject the pigmented ink In, a second treatment liquid head to eject the second treatment liquid P2, and a single carriage to mount them. Hereinafter, the configuration of the applying section 10 will be described in more detail with reference to FIG. 2. FIG. 2 is a schematic view schematically showing an example of a main part of a multi-pass type inkjet applying apparatus.

The applying section 10 illustrated in FIG. 2 includes a first treatment liquid head 1P1 as an inkjet head for the first treatment liquid P1 (refer to FIG. 1). Four ink heads 1Y, 1M, 1C, and 1K are provided as the inkjet heads for the pigmented ink In (see FIG. 1). Furthermore, the inkjet head 100 includes a second treatment liquid head 1P2 as an inkjet head for the second treatment liquid P2 (see FIG. 1). Note that the ink head 1Y is a head for yellow ink, and hereinafter, is also referred to as “yellow ink head 1Y” or “head 1Y for yellow ink”. The ink head 1M is a head for magenta ink, and hereinafter, is also referred to as “magenta ink head 1M” or “head 1M for magenta ink”. The ink head 1C is a head for cyan ink, and hereinafter, is also referred to as “cyan ink head 1C” or “head 1C for cyan ink”. The ink head 1K is a head for black ink, and hereinafter, is also referred to as “black ink head 1K” or “head 1K for black ink”. In the applying section 10, the first treatment liquid head 1P1, the four ink heads 1Y, 1M, 1C, 1K, and the second treatment liquid head 1P2 are mounted on one carriage 22. That is, the first treatment liquid head 1P1, the ink heads 1Y, 1M, 1C, 1K, and the second treatment liquid head 1P2 are mounted on the same carriage 22. Note that a configuration in which an inkjet head of the same color or another inkjet head of a different color is further added as the inkjet head for the pigment ink In, or a configuration in which any number of rows of the above-described configurations are provided may be adopted.

In FIG. 1, the conveyance direction of a textile T1 is indicated by an arrow. Essential constituent members of the textile printing apparatus 100 are the first treatment liquid head 1P1 (refer to FIG. 2), the ink heads 1Y, 1M, 1C, 1K (refer to FIG. 2), the second treatment liquid head 1P2 (refer to FIG. 2), and the controller 106. The textile printing apparatus 100 may include other constituent members in addition to the constituent members illustrated in FIG. 1, if necessary. Other constituent members include, for example, a fixing section (not illustrated) provided on the downstream side of the drying section 105 in the conveyance direction. Hereinafter, each constituent member of the textile printing apparatus 100 will be described.

### <Textile Feeder>

The textile T1 is installed in a textile feeding section 101 provided on the upstream side of the applying section 10 in the conveyance direction. The textile feeding section 101 includes a rotary shaft on which a roll-shaped textile T1 is mounted, a motor (not illustrated) that rotation-drives the rotary shaft in a predetermined rotation direction, and the like. The textile feeding section 101 feeds the textile T1 to the downstream side in the conveyance direction along the rotation of the rotary shaft by driving the motor. Note that the textile T1 may be a continuous textile as described above, or may be a textile separated into individual sheets.

### <Conveyer>

The conveyance section 103 conveys the textile T1 fed from the textile feeding section 101. In FIG. 1, a configuration is adopted in which the textile T1 is conveyed by the conveyance roller, but for example, a configuration may be adopted in which the textile T1 is attached to a conveyance belt and conveyed.

When the conveyance section 2 conveys the textile 3 attached to a conveyance belt, the following cleaning step is accompanied. Here, FIG. 4 is a diagram illustrating a schematic configuration of an inkjet textile printing apparatus in which a textile is conveyed while being attached to a conveyance belt. In the case of a configuration in which the sheet is conveyed while being attached to the conveyance belt, as illustrated in FIG. 4, a conveyance belt cleaning section 4 is arranged below the belt conveyance section 2. The conveyance belt cleaning section 4 is provided with a plurality of cleaning means and the like in order along a movement direction of the conveyance belt 223. Note that in the belt conveyance section 2, the drive roller 221 rotates at a predetermined speed in a counterclockwise direction (see the arrow) in FIG. 4 by rotational drive of the sub-scanning motor, thereby rotationally moving the conveyance belt 223 stretched between the drive roller 210 and the driven roller 222. Thus, a textile T2 placed on the upper surface of the conveyance belt 223 is conveyed in a direction indicated by arrow A in the drawing, which is a sub-scanning direction. In FIG. 4, reference sign 3 represents a applying section as an inkjet applying apparatus.

The conveyance belt cleaning section 4 includes a water spray pipe 41, a brush roller 42, a cleaning blade 43, a cleaning sponge 44, and a heating section 45.

The water spray pipe 41 is bridged over the entire width of the conveyance belt 223. In the water spray pipe 41, a large number of nozzles are arranged along the length direction in a portion facing the surface of the conveyance belt 223. The washing liquid is supplied to the water spray pipe 41 via the water spray tube 41a by driving of the water spray pump. The water spray pipes 41 spray the supplied cleaning liquid toward the surface of the conveyance belt 223 from the nozzles, thereby cleaning foreign matters attached to the surface of the conveyance belt 223.

The brush roller 42 is formed in a roller shape by planting a plurality of brush bundles, each of which is formed by bundling brush bristles, around a rotating shaft bridged over a full width of the conveyance belt 223. The tip of the brush bundle is always in contact with the surface of the conveyance belt 223 on the downstream side in the rotation direction of the conveyance belt 223 from the water spray position by the water spray pipe 41. The brush roller 42 is rotatably in contact with the surface of the conveyance belt 223, and removes foreign substances such as aggregates remaining on the surface of the conveyance belt 223. Specifically, the brush roller 42 rotates at a predetermined speed in the same direction as the rotation direction of the drive roller 21, based on the power of a brush drive section (not illustrated). Thus, the brush roller 42 moves in a direction opposite to the movement direction of the conveyance belt 223, and rubs the surface of the conveyance belt 223 with the tips of the brush bundles. Thus, the brush roller 42 removes the foreign matters cleaned by the spraying of the cleaning liquid by the water spray pipe 41 on the upstream side in the movement direction of the conveyance belt 223.

A cleaning tub for storing a cleaning liquid may be arranged below the brush roller 42. In this case, a lower portion of the brush roller 42 is partially immersed in the cleaning liquid, and scoops up the cleaning liquid during rotation, thereby enhancing the effect of removing foreign substances. Furthermore, the cleaning liquid in the cleaning tank may be supplied to the water spray pipe 41 via the water spray tube 41a. In this case, the cleaning liquid that has been sprayed onto the surface of the conveyance belt 223 and drips from the surface is collected in the cleaning tub to be reused.

The cleaning blade 43 is provided on the downstream side of the brush roller 42 in the rotation direction of the conveyance belt 223. The cleaning blade 43 is formed in the shape of a flat plate using, for example, an elastic material such as rubber, a PET sheet, a straight brush, or the like, and is stretched over the entire width of the conveyance belt 223. The cleaning blade 43 is configured such that its tip can be brought into contact with or separated from the surface of the conveyance belt 223. The cleaning blade 43 comes into contact with the surface of the conveyance belt 223, and scrapes and removes the foreign matter and the cleaning liquid remaining on the surface of the conveyance belt 223.

The cleaning sponge 44 is a water-absorbent porous body, such as a sponge, and is bridged over the entire width of the conveyance belt 223. The surface of the cleaning sponge 44 is configured to be able to abut on or separate from the surface of the conveyance belt 223 on the downstream side of the cleaning blade 43 in the rotation direction of the conveyance belt 223. The cleaning sponge 44 comes into contact with the surface of the conveyance belt 223 to absorb and wipe off the cleaning liquid remaining on the surface of the conveyance belt 223.

The heating section 45 is a belt heater and is provided on a downstream side of the cleaning sponge 44 and on an upstream side of the driven roller 222 in a rotation direction of the conveyance belt 223. The heating section 45 heats and evaporates the cleaning liquid remaining on the surface of the conveyance belt 223.

### <Applying Section>

As illustrated in FIG. 1, the applying section 10 is an inkjet applying apparatus for performing a process of applying the first treatment liquid P1, the pigmented ink In, and the second treatment liquid P2 to the textile T1. In particular, the applying section 10 is a multi-pass inkjet applying apparatus.

As illustrated in FIG. 2, an image is formed as a droplet ejecting means 20 of the inkjet applying apparatus moves in a scanning direction on a textile T1 while ejecting a first treatment liquid P1 (not illustrated), a pigmented ink In (not illustrated) of each color, and a second treatment liquid P2 (not illustrated). As the pigment ink In, for example, four color inks of yellow ink Y, magenta ink M, cyan ink C, and black ink K are used. Here, in FIG. 2, a plane parallel to the textile T1 is defined as an “X-Y plane”. The direction orthogonal to the “X-Y plane” is defined as a “Z direction”. For example, the direction in which ink is ejected by the pigmented ink heads 1Y, 1M, 1C, and 1K mounted on the carriage 22 corresponds to the Z direction. In the above-described X-Y plane, a main scanning direction is defined as an “X direction” and a direction (a sub-scanning direction) orthogonal to the main scanning direction is defined as a “Y direction”. Hereinafter, the X direction may be referred to as a “main scanning direction X”. Further, the Y direction may be referred to as a “sub-scanning direction Y” or a “conveyance direction Y”.

The textile T1 is sequentially conveyed in a sub-scanning directionY orthogonal to the scanning direction X by a conveyance section (not illustrated), so that an image can be formed on substantially the entire front surface (image forming face) of the textile T1.

The droplet ejecting means 20 includes a first treatment liquid head 1P1, four ink heads 1Y, 1M, 1C, 1K, a second treatment liquid head 1P2, and a carriage 22 for arranging and holding these heads along the scanning direction X. That is, the first treatment liquid head 1P1, the ink heads 1Y, 1M, 1C, and 1K, and the second treatment liquid head 1P2 are mounted on the same carriage 22. Hereinafter, the first treatment liquid head 1P1, the four ink heads 1Y, 1M, 1C, 1K, and the second treatment liquid head 1P2 are collectively referred to as a “head unit 1”.

In the head unit 1, the first treatment liquid head 1P1, the four ink heads 1Y, 1M, 1C, 1K, and the second treatment liquid head 1P2 are arranged in the following order in the forward path in which the droplet ejecting means 20 moves once in the scanning direction X. That is, in the forward path, the first treatment liquid head 1P1, the yellow ink head 1Y, the magenta ink head 1M, the cyan ink head 1C, the black ink head 1K, and the second treatment liquid head 1P2 are arranged in this order from the head in the scanning direction. On the other hand, in the return path, the second treatment liquid head 1P2, the black ink head 1K, the cyan ink head 1C, the magenta ink head 1M, the yellow ink head 1Y, and the first treatment liquid head 1P1 are arranged in this order from the head in the scanning direction.

A plurality of nozzles (not shown) are arranged in the conveyance direction Y orthogonal to the scanning direction X on a face (nozzle face) of each head facing the textile T1. Then, appropriate pressures are applied to the pigmented ink In, the first treatment liquid P1, and the second treatment liquid P2 to eject minute droplets from the nozzles. The droplet ejecting means 20 is supported in a state where a nozzle face in the head unit 1 is separated from the face of the textile T1 by a predetermined gap in a direction orthogonal to the face (height direction).

The droplet ejecting means 20 is scanned in the scanning direction X by the scanning section 30. The scanning section 30 includes, for example, a rail that supports the carriage 22 in a state in which the nozzle surfaces are separated from the surfaces of the textile T1 in the height direction by the above-described predetermined distances, and enables the carriage 22 to move along the rail extending along the scanning direction X.

When the droplet ejecting means 20 moves once in the scanning direction X in the forward path, the applying of each of the pigmented inks In is performed immediately after the first treatment liquid P1 is applied in a predetermined range along the scanning direction X of the head unit 1, and the applying of the second treatment liquid P2 is performed immediately after the pigmented ink is applied.

Thereafter, the textile T1 moves in the conveyance direction Y, and the droplet ejecting means 20 moves once in the scanning direction X in a return path. When the droplet ejecting means 20 moves once in the scanning direction X on the return path, each pigmented ink In is applied immediately after the second treatment liquid P2 is applied in a predetermined length along the scanning direction X of the head unit 1, and the first treatment liquid P1 is applied immediately after each pigmented ink is applied.

In the multi-pass applying method as illustrated in FIG. 2, an operation of applying the pigmented ink In, the first treatment liquid P1, and the second treatment liquid to the textile T1 by one movement of the droplet ejecting means 20 in the scanning direction X is defined as one printing pass, and a plurality of printing passes are performed on the same area. By performing such a plurality of printing passes, a desired image is finally formed on the textile T1.

The inkjet textile printing method of the present invention forms an image by, for example, using the inkjet applying apparatus illustrated in FIG. 2, applying the first treatment liquid P1, the pigmented ink In, and the second treatment liquid P2 to the textile T1 by the droplet ejecting means 20, respectively, and causing them to coalesce, as described above.

Note that the ejection method of the first treatment liquid P1, each of the pigmented inks In, and the second treatment liquid P2 in the head unit 1 is not particularly limited, and either an on-demand head or a continuous head may be used. Examples of the on-demand type head include an electro-mechanical conversion type and an electrothermal conversion type. Examples of the electro-mechanical conversion method include electro-mechanical conversion methods such as a single cavity type, a double cavity type, a bender type, a piston type, a share mode type, and a shared wall type. Examples of the electrothermal conversion system include electrothermal conversion systems such as a thermal inkjet type and a bubble jet (R) type.

Among the above, a head of an on-demand method is preferable, and a head using a piezoelectric element as an electromechanical conversion element used in an electromechanical conversion method (also referred to as a “piezo type inkjet head”) is preferable.

### <Dryer>

The drying section 105 dries the first treatment liquid P1, the pigmented ink In, and the second treatment liquid P2 applied by the applying section 10. The drying means is not particularly limited, but heating with warm air, a hot plate, a heat roller, or infrared drying is preferable. From the viewpoint of sufficiently removing the solvent component in a short time, heat drying is more preferable. The drying temperature is preferably within a range of 100 to 200° C.

### <Textile Collection Section>

The textile collection section 102 is provided on the downstream side of the drying section 105, and collects the printed textile T3, on which the first treatment liquid P1, the pigmented ink In, and the second treatment liquid P2 have been dried in the drying section 105, while winding up the printed textile SL. Alternatively, the textile collection section 102 in the case of a configuration in which the textile T1 separated one by one is conveyed may be a textile discharge section to which the printed textile T3 is discharged.

Examples of the type of fiber forming the textile include natural fibers (hydrophilic fibers) such as cotton, hemp, wool, and silk, chemical fibers such as rayon, vinylon, nylon, acrylic, polyurethane, polyester, and acetate, and blends thereof.

### <Controller>

The controller 106 controls each constituent member of the textile printing apparatus 100 described so far. For example, the controller 106 controls each of the textile feeding section 101, the conveyance section 103, the drying section 105, and the textile collection section 102. Furthermore, the controller 106 is not particularly limited, but may control the applying conditions of the first treatment liquid P1 and the second treatment liquid P2 on the basis of the textile information. Specific examples include controlling the applying amounts of the first treatment liquid P1 and the second treatment liquid P2 on the basis of textile information (e.g., the fiber ratio, the basis weight, and the fiber type of the textile).

### [Inkjet Textile Printing Method]

Next, the inkjet textile printing method (also simply referred to as “textile printing method”) of the present embodiment will be described in more detail. The textile printing method of the present embodiment is a textile printing method of applying a pigment ink, a first treatment liquid, and a second treatment liquid with inkjet heads. Hereinafter, the first treatment liquid and the second treatment liquid may be collectively and simply referred to as “treatment liquids”.

The printing method according to the present embodiment forms an image by applying the pigmented ink In, the first treatment liquid P1, and the second treatment liquid P2 with inkjet heads, for example, using the printing apparatus 100 as illustrated in FIG. 1 described above. In particular, the textile printing method according to the present embodiment arranges the inkjet head ejecting the first treatment liquid, the inkjet head ejecting the pigment ink, and the inkjet head ejecting the second treatment liquid in the same carriage, and forms an image in a multi-pass system. More specifically, in the forward path of the multi-pass method, after the first treatment liquid is applied, the pigment ink and the second treatment liquid are applied in this order. On the other hand, in the return path of the multi-pass method, the second treatment liquid is applied, and then the pigment ink and the first treatment liquid are applied in this order. Such a step can be performed using, for example, an inkjet applying apparatus illustrated in FIG. 2. That is, using the inkjet applying apparatus illustrated in FIG. 2, the first treatment liquid P1, the pigmented ink In, and the second treatment liquid P2 are each applied to the textile T1 by the droplet ejecting means 20, and are combined to form an image. The configurations of the textile printing apparatus 100 illustrated in FIG. 1 and the inkjet applying apparatus illustrated in FIG. 2 are as described in the embodiment of the textile printing apparatus.

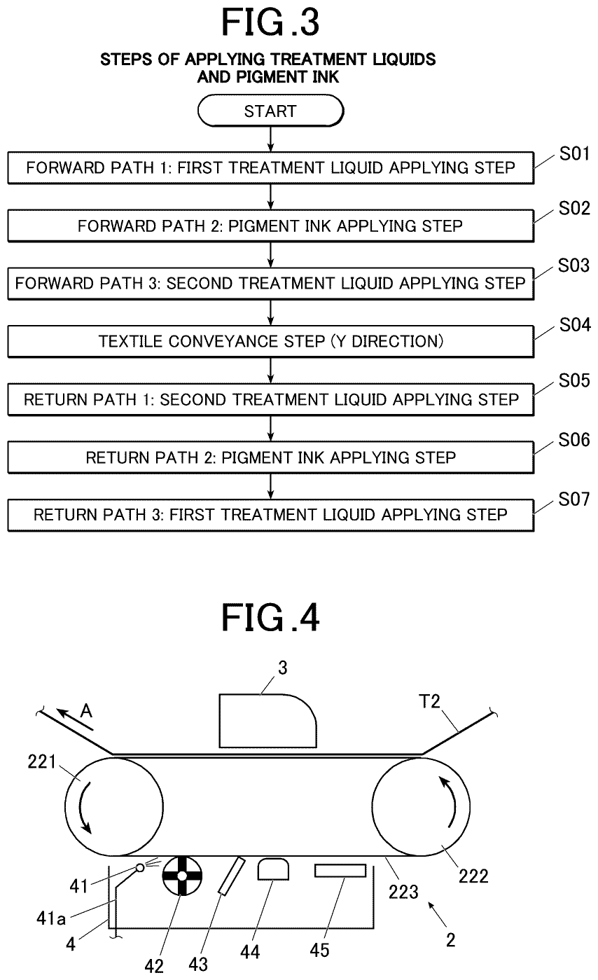

For example, as the steps of applying a treatment liquid and a pigmented ink, as illustrated in the flowchart of FIG. 3, a first treatment liquid applying step S01 on forward path 1, a pigmented ink applying step S02 on forward path 2, and a second treatment liquid applying step S03 on forward path 3 are performed on the return path of the multi-pass method. Thereafter, after the conveyance step S04 of the textile in which the textile is conveyed in the conveyance direction Y is performed, the second treatment liquid applying step S05 of the return path 1, the pigmented ink applying step S06 of the return path 2, and the second treatment liquid applying step S07 of the return path 3 are performed in the return path of the multi-pass method. Here, FIG. 3 is a flowchart illustrating an example of a step of applying the treatment liquid and the pigment ink in the multi-pass method.

In the printing method of the present embodiment, the first treatment liquid P1 (refer to FIG. 1, the same applies hereinafter) that is ejected first in the forward path contains a flocculant. The first treatment liquid P1 is for retaining at least one of the pigmented ink In (see FIG. 1, the same applies hereinafter) and the second treatment liquid P2 (see FIG. 1, the same applies hereinafter) on the surfaces of the textiles. The second treatment liquid P2 that is injected first in the return path contains the silicone acrylic resin and first resin particles having a film elongation of 600 to 1600%. The printing method of the present embodiment is characterized in that the first treatment liquid P1, the pigmented ink In, and the second treatment liquid P2 are attached to the same spot in the same scanning (main scanning) while undried, by the forward path and the return path of the multi-pass method as described above.

In the printing method of the present embodiment, after the first treatment liquid P1, the pigmented ink In, and the second treatment liquid P2 are applied as described above, the applied first treatment liquid P1, pigmented ink In, and second treatment liquid P2 may be dried by the drying section 105 of the printing apparatus 100 as illustrated in FIG. 1.

Thereafter, if necessary, volatile components in the first treatment liquid P1, the pigmented ink In, and the second treatment liquid P2 are removed by the fixing section in the drying section 105 of the printing apparatus 100, and then the remainder is fixed on the textile T1 by further heating or the like.

Furthermore, the printed textile T3 dried in the drying section 105 after printing is collected while being wound up by the textile collection section T3 of the printing apparatus 100.

By the printing method as described above, an image having good wet friction robustness can be formed on a textile without impairing the texture. Hereinafter, the first treatment liquid, the second treatment liquid, and the pigment ink used in the textile printing method of the present embodiment will be described.

### <First Treatment Liquid>

The first treatment liquid contains a flocculant.

### (Flocculant)

The type of the flocculant is not particularly limited as long as the flocculant aggregates the pigment or the like contained in the ink. The aggregation may be carried out using a change in pH or using an electrical action.

Examples of the flocculant that causes aggregation by a change in pH include organic acids. Examples of the organic acid include carboxylic acids having 6 or less carbon atoms, such as saturated fatty acids (e.g., formic acid, acetic acid, propionic acid, butyric acid, valeric acid, and hexanoic acid) and hydroxy acids (e.g., lactic acid, malic acid, and citric acid).

Examples of the flocculant which causes aggregation by an electrical action include a compound having a cationic group and a polyvalent metal salt. These flocculants can interact or react with the anionic block copolymer which is a pigment dispersant contained in the ink.

Examples of the cationic group in the compounds having a cationic group include a secondary amino group, a tertiary amino group, and a quaternary ammonium group. Examples of the compounds having a cationic group include cationic resins and cationic surfactants, with cationic resins being preferred.

Examples of the cationic resin include a cationic urethane resin, a cationic olefin resin, and a cationic alkylamine resin. Examples of commercially available products include MPT-60 (manufactured by Mitsubishi Pencil Company, Ltd.), UNISENCE KHE100L (manufactured by Senka Corporation), and MZ-477 (an urethane resin, manufactured by Takamatsu Oil & Fat Co., Ltd.). Among them, cationic alkylamine resins MPT-60 and UNISENCE KHE100L (manufactured by Senka Corporation) are preferable from the viewpoint that they more easily interact or react with the block copolymers.

The polyvalent metal salt may be a water-soluble compound having a divalent or higher polyvalent metal ion and an anion to be bonded thereto. Examples of the polyvalent metal ion include a divalent metal ion such as Ca²⁺, Cu²⁺, Ni²⁺, Mg²⁺, Zn², and Ba²⁺, and a trivalent metal ion such as Al³⁺, Fe³⁺, and Cr³⁺. Examples of the anion include Cl⁻, I⁻, Br⁻, SO²⁻, ClO³⁻, NO³⁻ and HCOO⁻, CH₃COO⁻. Examples of such polyvalent metal salts include: zinc acetate dihydrate, magnesium nitrate, calcium chloride, magnesium chloride, aluminum chloride, magnesium sulfate; and metal salts of organic acids such as calcium salts, magnesium salts, nickel salts and aluminum salts of acetic acid and the like. Among them, calcium salts and magnesium salts are preferable, and calcium nitrate and calcium chloride are preferable.

Among them, a compound having a cationic group or a metal salt of an organic acid is preferable, and a compound having a cationic group is more preferable.

The content of the flocculant in the first treatment liquid is not particularly limited, but is preferably 0.1 to 15 mass % and more preferably 0.5 to 8 mass % relative to the first treatment liquid.

### <Second Treatment Liquid> (Silicone Acrylic Resin)

The second treatment liquid contains a silicone acrylic resin. The silicone acrylic resin is a silicone acrylic resin present in a state of being dispersed as resin particles in an aqueous medium. The second treatment liquid is an aqueous treatment liquid containing water and a suitable water-soluble organic solvent. Therefore, the silicone acrylic resin is also contained as resin particles in the second treatment liquid. Whether the silicone acrylic resin is present as resin particles can be confirmed by determining whether there is a peak corresponding to the silicone acrylic resin when the dispersed particle size (Z average) of the second treatment liquid is measured by a particle size measuring apparatus. An example of the particle size measuring apparatus includes “Zataizer Nano S90” manufactured by Melvern Instruments Inc.

The silicone acrylic resin is a copolymer containing a structural unit derived from a polyorganosiloxane and a structural unit derived from another polymerizable monomer (including a macromonomer) copolymerizable with the structural unit derived from a polyorganosiloxane.

The copolymer may be, for example, a graft copolymer in which the structural unit derived from a polyorganosiloxane and a (meth)acrylic acid ester or the like (polymerizable monomer) are graft-polymerized. Furthermore, the copolymer may be, for example, a copolymer in which a side chain or an end of a (meth)acrylic resin or the like is modified with a polyorganosiloxane. Among them, a graft copolymer in which a (meth)acrylic acid ester or the like is graft-polymerized to a polymer containing the structural unit derived from a polyorganosiloxane is preferable. Such a graft copolymer has a structure in which the polyorganosiloxane portion serves as a trunk portion and the (meth)acrylic acid ester or the like serves as a branch portion and thus is more compatible with a binder resin contained in the ink layer, which is preferable. Note that the form of the copolymerization is not limited to graft copolymerization and may be random copolymerization or block copolymerization.

The silicone acrylic resin may also include an ionic group. The ionic group of the silicone acrylic resin may be an ionic group that forms a pair with an ionic group of the textile (or an ionic group of the flocculant attached to the textile). For example, since the flocculant usually has a cationic group, the silicone acrylic resin may be an anionic silicone acrylic resin having an anionic group. Examples of the anionic group include a carboxy group, a sulfonic acid group and a phosphonic acid group.

That is, the silicone acrylic resin preferably contains a structural unit derived from a polyorganosiloxane having a radical polymerizable group and a structural unit derived from another polymerizable monomer copolymerizable with the structural unit derived from a polyorganosiloxane.

Examples of the polyorganosiloxane having a radical polymerizable group include polyorganosiloxanes represented by the following Formula (1).

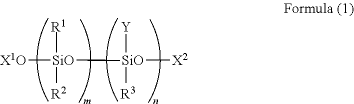

In the above Formula (1), R¹, R² and R³ are each independently a hydrocarbon group having 1 to 10 carbon atoms.

In the above formula (1), Y is a radical polymerizable group selected from the group consisting of a vinyl group, an allyl group, and a γ-(meth)acryloxypropyl group.

In the above Formula (1), X¹ and X² are each independently a hydrogen atom, an alkyl group having 1 to 10 carbon atoms, or a group represented by Formula (2): SiR⁴R⁵R⁶. m is an integer of 1 to 10000. n is an integer of 1 or more. The siloxane chain may be branched.

In the above Formula (2): SiR⁴R⁵R⁶, R⁴ and R⁵ are each independently a hydrocarbon group having 1 to 10 carbon atoms. R⁶ is a radical polymerizable group selected from the group consisting of a vinyl group, an allyl group, and a γ-(meth)acryloxypropyl group, or a hydrocarbon group having 1 to 10 carbon atoms.

Examples of the other polymerizable monomer include (meth)acrylic acid esters. In the present specification, (meth)acryl represents acryl, methacryl, or both of them.

The (meth)acrylic acid ester is an alkyl ester, a hydroxyalkyl ester, or an alkoxyalkyl ester of (meth)acrylic acid. Examples of the (meth)acrylic acid ester include methyl (meth)acrylate, ethyl (meth)acrylate, isopropyl (meth)acrylate, n-propyl (meth)acrylate, n-butyl (meth)acrylate, and isobutyl (meth)acrylate. Other examples of the (meth)acrylic acid ester include 2-ethylhexyl (meth)acrylate, isooctyl (meth)acrylate, n-octyl (meth)acrylate, 2-hydroxyethyl (meth)acrylate, and 2-methoxyethyl (meth)acrylate. Among them, methyl methacrylate and 2-hydroxyethyl methacrylate are preferable.

The content of the structural unit derived from a polyorganosiloxane in the silicone acrylic resin is preferably 50% by mass or more, and more preferably 60% by mass or more and 95% by mass or less relative to the total amount of the structural units constituting the silicone resin. When the content of the structural unit derived from a polyorganosiloxane is 50% by mass or more, the effect of reducing the friction coefficient derived from the polysiloxane can be more easily obtained, and the wet friction robustness can be further improved. If the content of the structural unit derived from polyorganosiloxane is 95% by mass or less, the affinity between another compound and another resin is more likely to be increased.

The silicone acrylic resin may further include a structural unit derived from a polymerizable monomer other than the above-described polymerizable monomers. Examples of the polymerizable monomer other than those described above include styrenes and ethylenically unsaturated carboxylic acids such as (meth)acrylic acid. For example, from the viewpoint of exhibiting anionic properties, the silicone acrylic resin may further include a structural unit derived from an ethylenically unsaturated carboxylic acid such as (meth)acrylic acid.

The graft copolymerization can be performed by a known method. For example, the graft copolymerization can be performed by emulsifying and dispersing a polyorganosiloxane represented by Formula (1) above and a copolymerizable compound such as a (meth)acrylic acid ester in water and polymerizing the mixture in the presence of a radical polymerization initiator.

Examples of commercially available products of the silicone, (meth) acrylic copolymers include CHALINE LC190, CHALINE R-170, R170S, CHALINE FE-230N, FE-502, and R-170BX (manufactured by Nissin Chemical Industry Co., Ltd).

Although the second treatment liquid contains the silicone acrylic resin described above, for example, when the amount of a surfactant is increased instead of the silicone acrylic resin in the second treatment liquid, ionic bond between an anion and a cation may be inhibited, and the wet friction may be deteriorated. In addition, when the amount of a surfactant is increased, the friction coefficient of the surface is also increased, and the dry friction may be deteriorated.

In addition, it is preferable that the second treatment liquid does not actively contain a flocculant such as the first treatment liquid described above. If the second treatment liquid actively contains a flocculant, the coefficient of friction of the surface to which the second treatment liquid has been applied may increase, the dry friction robustness may deteriorate, and the surface may become sticky.

### (First Resin Particles Having a Film Elongation of 600 to 1600%)

The second treatment liquid contains the first resin particles having a film elongation of 600 to 1600%. The first resin particles having a film elongation of 600 to 1600% are present in a state of being dispersed in an aqueous medium. Hereinafter, the first resin particles having a film elongation of 600 to 1600% may be simply referred to as “first resin particles”.

The type of the resin of the first resin particles contained in the second treatment liquid is not particularly limited as long as the film elongation is 600 to 1600%, and examples thereof include a urethane resin, an acrylic resin, and an ester resin. The resin forming the first resin particles preferably includes a urethane resin or an acrylic resin. The inclusion of a urethane resin or an acrylic resin is advantageous in that good flexibility is provided and the texture of the textile is more easily maintained. As the urethane resin and the acrylic resin constituting the first resin particles, for example, a urethane resin and an acrylic resin exemplified in “Water—Dispersible Resin: Second Resin Particles” contained in the pigment ink to be described later can be mentioned as preferred examples.

The film elongation (%) of the first resin particles was measured as follows. First, a resin composed of resin particles to be measured is applied onto a polytetrafluoroethylene sheet so that the film thickness after drying is 500 μm. Then, the applied resin is dried at normal temperature and normal pressure, that is, at 20° C. and 65% RH for 15 hours, further dried at 80° C. for 6 hours and at 120° C. for 20 minutes, and then peeled off from the sheet to produce a resin film. Then, the film elongation (%) of the obtained resin film is measured using a tensile tester under the conditions of a measurement temperature of 20° C. and a measurement speed of 200 mm/min. Specifically, the resin film is elongated under the above-described conditions, and the length by which the resin film is elongated until it is broken is measured. Then, a value obtained by expressing the ratio thereof to the original length of the resin film in percentage is defined as the film elongation (%) of the first resin particles. As the tensile tester, for example, a Tensilon universal tester “RTC 1225A (trade name)” manufactured by Orientec Co., Ltd. or a tester similar thereto can be used.

The film elongation of the first resin particles may be 600% to 1600%.

The respective contents of the first resin particles and the silicone acrylic resin in the second treatment liquid are not particularly limited. For example, the content of the silicone acrylic resin in the second treatment liquid is preferably 0.1 to 2.0 mass % and more preferably 0.5 to 1.0 mass % with respect to the second treatment liquid. Furthermore, for example, the content of the first resin particles in the second treatment liquid is preferably 5.0 to 15.0 mass %, more preferably 7.5 to 12.5 mass % relative to the second treatment liquid.

### <Pigment Ink>

The pigment ink contains a pigment and water.

### (Pigment)

The pigment is not particularly limited, and examples thereof include organic pigments or inorganic pigments having the following numbers described in the Color Index.

Examples of the red or magenta pigment include the following. Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 254, 257, Pigment Violet 3, 19, 23, 29, 30, 37, 50, 88, Pigment Orange 13, 16, 20, 34, 36, 43. Alternatively, a mixed crystal may be used.

Examples of blue or cyan pigments include the following: Pigment Blue 1, 15, 15:1, 15:2, 15:3, 15:4, 15:6, 16, 17-1, 22, 27, 28, 29, 36, 60.

Examples of green pigments include Pigment Green 7, 26, 36, and 50.

Examples of yellow pigments include the following: Pigment Yellow 1, 3, 12, 13, 14, 17, 34, 35, 37, 55, 74, 81, 83, 93, 94-, -95, 97, 108, 109, 110, 137, 138, 139, 153, 154, 155, 157, 166, 167, 168, 180, 185, 193.

Examples of black pigments include Pigment Black 7, 28, and 26.

Commercial examples of pigments include the following: Chromofine Yellow 2080, 5900, 5930, AF-1300, 2700 L, Chromofine Orange 3700 L, 6730, Chromofine Scarlet 6750, Chromofine Magenta 6880, 6886, 6891 N, 6790, 6887, Chromofine Violet RE, Chromofine Red 6820, 6830, Chromofine Blue HS-3, 5187, 5108, 5197, 5085 N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seika Fast Yellow 10GH, A-3, 2035, 2054, 2200, 2270, 2300, 2400 (B), 2500, 2600, ZAY-260, 2700(B), 2770, Seika Fast Red 8040, C405(F), CA120, LR-116, 1531B, 8060R, 1547, ZAW-262, 1537B,GY, 4R-4016, 3820, 3891, ZA-215, Seika Fast Carmine 6B1476T-7, 1483LT, 3840, 3870, Seika Fast Bordowic10B-430, Seika light RoseR40, Seika Light Violet B800, 7805, Seika Fast Maroon 460N., Seika Fast Orange 900, 2900, Seika light blueC718, A612, Cyanine Blue4933M, 4933GN-EP, 4940, 4973 (manufactured by Dainichiseika kogyo, Inc): KET Yellow 401, 402, 403, 404, 405, 406, 416, 424, KET Orange 501, KET Red 301, 302, 303, 304, 305, 306, 307, 308, 309, 310, 336, 337, 338, 346, KET Blue 101, 102, 103, 104, 105, 106, 111, 118, 124, KET Green 201 (manufactured by Dainippon Ink and Chemicals, Inc); Colortex Yellow 301, 314, 315, 316, P-624, 314, U10GN, U3GN, UNN, U A-414, U263, Finecol Yellow T-13, T-05, Pigment Yellow1705, Colortex Orange 202, Colortex Red101, 103, 115, 116, D3B, P-625, 102, H-1024, 105C, UFN, UCN, UBN, U3BN, URN, UGN, UG276, U456, U457, 105C, USN, Colortex Maroon601, Colortex BrownB610 N, Colortex Violet600, Pigment Red 122, ColortexBlue516, 517, 518, 519, A818, P-908, 510, Colortex Green402, 403, Colortex Black 702, U905 (manufactured by Sanyo Color Works, Ltd); Lionol Yellowl405G, Lionol Blue FG7330, FG7350, FG7400G, FG7405G, ES, ESP-S (manufactured by Toyo Ink Mfg. Co., Ltd), Toner Magenta E02, Permanent RubinF6B, Toner Yellow HG, Permanent Yellow GG-02, Hostapeam BlueB2G (manufactured by Hoechst Industries, Ltd); Novoperm P-HG, Hostaperm Pink E, Hostaperm Blue B2G (manufactured by Clariant); Carbon Black #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, and CF9 (manufactured by Mitsubishi Chemical Corporation).

### (Self-Dispersible Pigment)

The pigment may be a self-dispersible pigment. The self-dispersible pigment is obtained by modifying the surface of pigment particles with a group having a hydrophilic group. The self-dispersible pigment includes pigment particles and a hydrophilic group bonded to the surface of the pigment particles.

Examples of the hydrophilic group include a carboxy group, a sulfonic acid group, and a phosphorus-containing group. Examples of the phosphorus-containing group include a phosphoric acid group, a phosphonic acid group, a phosphinic acid group, a phosphite group, and a phosphate group.

Examples of commercially available products of the self-dispersible pigment include CAB-O-JET (R) 200K, 250C, 260M, and 270 V (sulfonic acid group-containing self-dispersible pigments) manufactured by Cabot Corporation. Other examples of commercially available products of the self-dispersible pigment include CAB-O-JET (R) 300K (carboxylic acid group-containing self-dispersible pigments) and CAB-O-JET (R) 400K, 450C, 465M, 470 V, and 480 V (phosphoric acid group-containing self-dispersible pigments) manufactured by Cabot Corporation.

The content of the pigment is not particularly limited, but is preferably in a range of 1.5 to 15 mass % with respect to the ink, from the viewpoint of facilitating adjustment of the viscosity of the ink to the above-described range and enabling formation of a high-density image. When the content of the pigment is 1.5 mass % or more, a high-density image is easily formed, and when the content is 15 mass % or less, the viscosity of the ink does not become too high, so that the ejection stability is hardly impaired. From the same viewpoint, the content of the pigment is more preferably in a range of 5 to 15 mass % with respect to the ink.

### (Water-Dispersible Resin: Second Resin Particles)

The pigment ink may further contain a water-dispersible resin. The water-dispersible resin has a function of fixing the pigment or the like to the textile. The water-dispersible resin may be contained in the ink as resin particles (second resin particles).

Examples of the water-dispersible resin include a urethane-based resin, a butadiene-based resin, an acrylic-based resin, and polystyrene. Examples of the butadiene-based resin include a styrene-butadiene copolymer and an acrylonitrile-butadiene copolymer. Examples of the acrylic-based resin include an acrylic acid ester copolymer, a styrene-acrylic copolymer, a silicone-acrylic copolymer, and an acrylic-modified fluorine resin. Among them, a urethane-based resin and an acryl-based resin such as an acrylic acid ester copolymer and a styrene-acryl copolymer are preferable. It is presumed that these are bonded to the block copolymer by an intermolecular hydrogen bond, the adhesiveness of the pigment to the textile is more easily enhanced, and the friction robustness is more easily enhanced.

Examples of the styrene-acrylic copolymer include a styrene-(meth)acrylic acid copolymer and a styrene-(meth)acrylic acid-(meth)acrylic acid ester copolymer. Examples of the (meth)acrylic acid ester include benzyl (meth)acrylate, cyclohexyl (meth)acrylate, methyl (meth)acrylate, ethyl (meth)acrylate, propyl (meth)acrylate, butyl (meth)acrylate, hexyl (meth)acrylate, octyl (meth)acrylate, lauryl (meth)acrylate, 2-ethylhexyl (meth)acrylate, 2-ethylhexylcarbitol (meth)acrylate, phenol EO-modified (meth)acrylate, isobornyl (meth)acrylate, dicyclopentenyl (meth)acrylate, dicyclopentanyl (meth)acrylate, and dicyclopentenyloxyethyl (meth)acrylate.

The urethane resin is a polymer obtained by reacting a polyol with a polyisocyanate. Examples of the polyol include polypropylene glycol, polyethylene glycol, polytetramethylene glycol, poly(ethylene adipate), poly(diethylene adipate), poly(propylene adipate), poly(tetramethylene adipate), poly(hexamethylene adipate), poly-ε-caprolactone, poly(hexamethylene carbonate), and silicone polyols. Examples of the isocyanate include tolylene diisocyanate, 4,4-diphenylmethane diisocyanate, xylylene diisocyanate, naphthalene diisocyanate, and hexamethylene diisocyanate. Note that other examples of the isocyanate include hydrogenated tolylene diisocyanate, hydrogenated 4,4-diphenylmethane diisocyanate, isophorone diisocyanate, and tetramethylxylylene diisocyanate.

The average particle size of the water-dispersible resin is not particularly limited, but is preferably 300 nm or less, and more preferably 130 nm or less, from the viewpoint of making nozzle clogging of an inkjet head less likely to occur. The average particle size of the water-dispersible resin can be measured by laser diffraction scattering particle size distribution measurement.

The content of the water-dispersible resin is preferably 1 to 15 mass % relative to the ink. When the content of the water-dispersible resin is 1% by mass or more, the viscosity of the ink is likely to be moderately increased, and thus not only the ejection stability can be further increased, but also the adhesion of the obtained image to textile and the abrasion resistance are likely to be increased. When the content of the water-dispersible resin is 15 mass % or less, the viscosity of the ink does not become excessively high, and thus nozzle clogging or the like is less likely to occur. From the same viewpoint, the content of the water-dispersible resin is more preferably 2 to 10 mass % relative to the ink.

### (Silicone Acrylic Resin)

The pigment ink may further contain a silicone acrylic resin. As the silicone acrylic resin, a silicone acrylic resin formed in the same manner as the silicone acrylic resin contained in the first treatment liquid described above can be suitably used.

### (Block Copolymer)

The pigment ink may contain a pigment and a block copolymer. In addition, it is preferable that the block copolymer contains two hydrophilic blocks A which are arranged at both ends of the molecule and interact or react with the flocculant, and a hydrophobic block B which is arranged between the two hydrophilic blocks A. In particular, the block copolymer more preferably contains an ABA-type block copolymer composed of two hydrophilic blocks A and one hydrophobic block B. Note that the block copolymer may be contained as a pigment dispersant or may be contained as a fixing resin. For example, in the present embodiment, the block copolymer is contained as a pigment dispersant.

Conventionally, for example, a random copolymer or an AB-type block copolymer is used as a pigment dispersant contained in a pigment ink. For example, the random copolymer is a copolymer randomly including a moiety that interacts or reacts with a flocculant. For example, the AB-type block copolymer is a copolymer having a block (usually, hydrophilic block A) containing many sites which interact or react with an flocculant at only one position of one terminal of the molecule.

Since the random copolymer does not have a block containing many moieties that interact or react with a flocculant, the random copolymer is less likely to interact or react with the flocculant. Although the AB-type block copolymer has a block containing many sites that interact or react with the flocculant, since the block is present at only one position of the molecular terminal, the number of bonding points that can be bonded to the textile may be reduced. Therefore, it is difficult to obtain adhesiveness of the copolymer to the textile, and the wet friction robustness and the dry friction robustness may be lowered. In addition, since the copolymer can be continuously (in the form of a film) bonded to the textile at one bonding point, the textile also tends to be hard.

On the other hand, the block copolymer of the ABA-type or the like contains blocks at both ends of the molecule that contain many moieties that interact or react with a flocculant. As described above, since the blocks are present at least two positions of both ends of the molecule, there are many binding points capable of binding to the textile, and the binding to the textile Tends to be strong. Thus, the adhesiveness to textile is improved, and the wet friction robustness and the dry friction robustness are likely to be enhanced. In addition, since the copolymer can be intermittently bonded to the textile at a plurality of bonding points, the textile is less likely to be hardened than when the copolymer is continuously bonded to the textile at one bonding point. Note that the block containing many moieties that interact or react with the flocculant is a hydrophilic block.

That is, the block copolymer preferably contains two hydrophilic blocks A arranged at both ends of the molecule and a hydrophobic block B arranged between the two hydrophilic blocks A.

The “hydrophilic block A” is a block that enhances the affinity with the aqueous solvent contained in the pigment ink and contains a site that interacts or reacts with the flocculant attached to the textile, and refers to a block having a higher affinity with water among the blocks constituting the copolymer. The number of the hydrophilic blocks is preferably two.

Each of the hydrophilic blocks A includes a structural unit derived from a monomer having a hydrophilic functional group (hereinafter, referred to as a “hydrophilic monomer”). Examples of the hydrophilic functional group include a hydroxyl group, a carboxyl group, and a sulfonic acid group.

Examples of the hydrophilic monomer constituting the hydrophilic block A include vinyl-based monomers containing a hydrophilic functional group. Examples of such vinyl-based monomers include: unsaturated polyvalent carboxylic acids such as (meth)acrylic acid and maleic acid; and monomers containing a carboxy group or an acid anhydride group, such as maleic anhydride. Other examples include monomers containing a sulfonic acid group, such as styrenesulfonic acid and 4-(methacryloyloxy) butylsulfonic acid. Still other examples include ethylene oxide-modified (meth)acrylic acid ester monomers such as ethylene oxide-modified (meth)acrylic acid alkyl esters. Among them, the hydrophilic monomer is preferably (meth)acrylic acid from the viewpoint of imparting moderate water solubility to the hydrophilic block A.

It is sufficient that the content of a structural unit derived from the hydrophilic monomer in the hydrophilic block A is greater than the content of a structural unit derived from a hydrophilic monomer in the hydrophobic block B. To be specific, the content of a structural unit derived from the hydrophilic monomer in the hydrophilic block A is preferably 5% by mass or more relative to 100% by mass of the hydrophilic block A. When the content of a structural unit derived from the hydrophilic monomer is 5% by mass or more, not only dispersibility in an aqueous solvent is more likely to be increased, but also the interaction or reaction with the flocculant is more likely to occur, thus the adhesiveness to the textile is more likely to be increased. From the same viewpoint, the content is more preferably 10 to 40% by mass.

Each of the hydrophilic blocks A may further include a structural unit derived from a monomer other than the hydrophilic monomer. Examples of the other monomer include alkyl (meth)acrylates, such as methyl (meth)acrylate and tert-butyl (meth)acrylate. Among them, alkyl esters having 2 or more carbon atoms, such as butyl (meth)acrylate, are preferable. This is because the glass transition temperature (Tg) of the block copolymer is low and the textile does not tend to become hard. However, the other monomer does not include a hydrophobic monomer, which will be described later.

The “hydrophobic block B” is a moiety attached to the pigment and refers to a block having less affinity with the aqueous solvent contained in the ink among the blocks constituting the copolymer. The number of the hydrophobic blocks B is preferably one.

The hydrophobic block B includes a structural unit derived from a monomer having a hydrophobic functional group (hereinafter, referred to as a “hydrophobic monomer”). Examples of the monomer having a hydrophobic functional group include vinyl-based monomers containing an aromatic ring group or an alicyclic hydrocarbon group.

Examples of the vinyl-based monomer containing an aromatic ring group include (meth)acrylates having an aromatic ring group, such as benzyl (meth)acrylate, phenyl (meth)acrylate, and phenoxyethyl (meth)acrylate. Other examples include aromatic vinyl-based monomers such as styrene, α-methylstyrene, 4-methylstyrene, 2-methylstyrene, 3-methylstyrene, 4-methoxystyrene, 2-hydroxymethylstyrene, and 1-vinylnaphthalene. Although not particularly limited, among these vinyl-based monomers containing an aromatic ring group, for example, a vinyl-based monomer containing an aromatic ring group having 6 to 15 carbon atoms is preferable.

Examples of the vinyl-based monomer containing an alicyclic alkyl group include (meth)acrylates having an alicyclic alkyl group. Examples of such (meth)acrylates include cyclohexyl (meth)acrylate, methylcyclohexyl (meth)acrylate, and cyclododecyl (meth)acrylate. Other examples include bomyl (meth)acrylate, isobornyl (meth)acrylate, dicyclopentanyl (meth)acrylate, dicyclopentenyl (meth)acrylate, and dicyclopentenyloxyethyl (meth)acrylate. Although not particularly limited, among these vinyl-based monomers containing an alicyclic alkyl group, a vinyl-based monomer containing an alicyclic alkyl group having 6 to 15 carbon atoms is preferable.

Among them, from the viewpoint of improving adsorption to the pigment, the hydrophobic monomer is preferably a vinyl-based monomer containing an aromatic ring group having 6 to 15 carbon atoms, such as styrene.

The content of a structural unit derived from the hydrophobic monomer in the hydrophobic block B is preferably 80% by mass or more relative to the hydrophobic block B. When the content is 80% by mass or more, the absorption to the pigment is more likely to be increased. From the same viewpoint, the content is more preferably more than 90% by mass, and even more preferably 95% by mass or more.

The hydrophobic block B may further include a structural unit derived from a monomer other than the hydrophobic monomer. Examples of the monomer other than the hydrophobic monomer include the other monomers and the hydrophilic monomers described above. However, when the hydrophobic block B contains a structural unit derived from the hydrophilic monomer, the content of a structural unit derived from the hydrophilic monomer in the hydrophobic block B is less than that in the hydrophilic block A. Specifically, the content of a structural unit derived from the hydrophilic monomer is preferably 20% by mass or less, more preferably less than 10% by mass, and still more preferably 5% by mass or less, relative to the hydrophobic block B. That is, of the two blocks, the hydrophilic block A and the hydrophobic block B, the hydrophobic block B has the smallest content of a structural unit derived from a hydrophilic monomer (the number of moles of a hydrophilic functional group).

The content of the hydrophobic block B in the ABA-type block copolymer is preferably 20% by mass or more and 80% by mass or less, more preferably 20% by mass or more and 50% by mass or less relative to the entire block copolymer. When the content is 20% by mass or more, since the content of the hydrophilic block A is small (or the molecular weight is small), crosslinking flocculation is more easily suppressed. On the other hand, when the content is 80% by mass or less, since the content of the hydrophilic block A is large (or the molecular weight is large), the affinity for an aqueous solvent is more easily enhanced.

When the hydrophilic block is represented by A and the hydrophobic block is represented by B, examples of the structure of the block copolymer include ABA-type and ABABA-type. In particular, the block copolymer is preferably an ABA-type block copolymer composed of two hydrophilic blocks A arranged at both ends of the molecule and a hydrophobic block B arranged therebetween.

The types and composition ratios of the monomers of the plurality of blocks A included in the block copolymer may be the same or different from each other. Furthermore, when the block copolymer includes a plurality of blocks B, the types and compositional ratios of the monomers of the plurality of blocks B may be the same or different from each other. In particular, the two hydrophilic blocks A preferably have the same monomer composition.

The weight average molecular weight of the block copolymer is preferably 5000 to 70000, and more preferably 7000 to 30000. As the weight-average molecular weight is larger, the dispersibility of the pigment in the aqueous solvent is more easily enhanced, and as the weight-average molecular weight is smaller, the bridging aggregation between the dispersed pigments is more easily suppressed. The weight average molecular weight of the block copolymer can be measured in terms of polystyrene by gel permeation chromatography.

The molecular weight distribution (PDI) ((weight average molecular weight (Mw) of block copolymer)/(number average molecular weight (Mn) of block copolymer)) is preferably 2.0 or less, and more preferably 1.8 or less. A lower PDI means that the molecular weight distribution is narrower and more uniform, resulting in better dispersibility.

The acid value of the block copolymer is, for example, preferably 40 to 400 mg KOH/g, more preferably 40 to 300 mg KOH/g, and further preferably 40 to 190 mg KOH/g. When the acid value is 40 mg KOH/g or more, the hydrophilicity of the pigment dispersant can be increased to further increase the dispersibility of the pigment. When the acid value is 400 mg KOH/g or less, the hydrophilicity of the pigment dispersant can be further prevented from being excessively increased, and the water resistance of the resulting image-formed product can be further increased. The acid number can be measured according to the measurement method of JIS K0070:1992.

The content of the block copolymer is preferably 10 to 50% by mass, more preferably 20 to 40% by mass relative to the pigment. When the content is 10% by mass or more, the dispersibility of the pigment in the pigment dispersion can be further enhanced. In addition, when the content of the pigment dispersant is 50% by mass or less, it is possible to further suppress an increase in the viscosity of the pigment dispersion due to excessive inclusion of the pigment dispersant. Here, the pigment dispersion refers to a dispersion in which a pigment is dispersed in a pigment dispersant.

The method for synthesizing the block copolymer is not particularly limited, but the block copolymer can be obtained by, for example, sequentially polymerizing vinyl monomers constituting the blocks by a living radical polymerization method.

### (Water-Soluble Organic Solvent)

The pigment ink, the first treatment liquid, and the second treatment liquid each preferably further contain a water-soluble organic solvent. As a result, the ejection stability by inkjet can be further enhanced.

The water-soluble organic solvents are not particularly limited as long as they are compatible with water. Examples thereof include polyhydric alcohols (e.g., dihydric alcohols such as ethylene glycol, diethylene glycol, triethylene glycol, polyethylene glycol, propylene glycol, dipropylene glycol, tripropylene glycol, and polypropylene glycol, and trihydric or higher hydric alcohols such as glycerin, trimethylolpropane, and hexanetriol); polyhydric alcohol ethers (e.g., ethylene glycol monomethyl ether, ethylene glycol monoethyl ether, ethylene glycol monobutyl ether, ethylene glycol monophenyl ether, diethylene glycol monomethyl ether, diethylene glycol monoethyl ether, diethylene glycol monobutyl ether, diethylene glycol dimethyl ether, propylene glycol monomethyl ether, and propylene glycol monoethyl ether); monohydric alcohols (e.g., methanol, ethanol, propanol, pentanol, hexanol, cyclohexanol, and benzyl alcohols); amines (e.g., ethanol amine, N-ethyldiethanolamine, morpholine, N-ethylmorpholine, ethylene diamine, diethylene diamine, and triethylene tetramine); amides (e.g., formaldehyde amide, N,N-dimethylformamide, N,N-dimethylacetamide); heterocycles (e.g., 2-pyrrolidone, N-methyl-2-pyrrolidone, N-cyclohexyl-2-pyrrolidone, 2-oxazolidone, and 1,3-dimethyl-2-imidazolidine); sulfoxides (e.g., dimethylsulfoxide); and sulfones (e.g., sulfolane).

In addition, from the viewpoint of further enhancing the ejection stability by inkjet, the water-soluble organic solvent preferably includes a water-soluble organic solvent having a boiling point of 180° C. or higher, preferably 190° C. or higher, and more preferably 200° C. or higher. Examples of the water-soluble organic solvent having a boiling point of 180° C. or higher include dihydric alcohols and trihydric or higher hydric alcohols. Examples of the dihydric alcohols include ethylene glycol (boiling point: 197° C.), 1,3-butanediol (boiling point: 208° C.), 1,6-hexanediol (boiling point: 223° C.), and polypropylene glycol. Examples of the trihydric or higher hydric alcohols include glycerin (boiling point: 290° C.) and trimethylolpropane (boiling point: 295° C.).

The content of the water-soluble organic solvent is, for example, preferably 10% by mass or more and 65% by mass or less, more preferably 20% by mass or more and 45% by mass or less relative to the second treatment liquid.

The content of the water is 30% by mass or more and 85% by mass or less and preferably 50% by mass or more and 75% by mass or less relative to the second treatment liquid.

### (Other Components)

The pigment ink, the first treatment liquid, and the second treatment liquid may further contain other components than those described above, if necessary. Examples of the other components include a surfactant and a preservative.

The surfactant can decrease the surface tension of the pigment ink, the first treatment liquid, and the second treatment liquid to increase the wettability thereof to the textile. The type of surfactant is not particularly limited, and may be, for example, an acetylene glycol-based surfactant, a silicone-based surfactant, or a fluorine-based surfactant.

Examples of the antiseptic or antifungal agent include aromatic halogen compounds (e.g., Preventol CMK), methylene dithiocyanate, halogen-containing nitrogen-sulfur compounds, 1,2-benzisothiazolin-3-one (e.g., PROXEL GXL), and the like.

The pigment ink may further contain a crosslinking agent for crosslinking the resin constituting the resin particles. The crosslinking agent is preferably a compound having, in the molecule, at least two functional groups that react with crosslinkable groups (a hydroxyl group, a carboxyl group, and a ketone group) of the resin particles. Examples of the crosslinking group that reacts with a hydroxyl group include an isocyanate group and a blocked isocyanate group. Furthermore, examples of the crosslinking group that reacts with a carboxy group include an oxazolyl group, an aziridine group, and a carbodiimide group. Furthermore, examples of the crosslinking group that reacts with a ketone group include a hydrazide group.

Specifically, examples of the crosslinking agent that reacts with a hydroxyl group include Fixer N (a blocked isocyanate-based crosslinking agent, manufactured by Matsui Shikiso Chemical Co., Ltd.). Examples of the crosslinking agent that reacts with a carboxy group include Fixer F (an aziridine-based crosslinking agent, manufactured by Matsui Shikiso Chemical Co., Ltd.). Examples of the crosslinking agent that reacts with a ketone group include adipic acid dihydrazide (ADH, hydrazine-based crosslinking agent).

For example, as the crosslinking agent contained in the pigment ink, adipic acid dihydrazide is most preferable from the viewpoint of long-term storage at room temperature and crosslinking at room temperature, and a combination with diacetone acrylamide (DAAM), which is a crosslinkable monomer that reacts with adipic acid dihydrazide, is most preferable. The content of the crosslinking agent in the pigment ink is not particularly limited.

### <Preparation of Pigment Ink, First Treatment Liquid, and Second Treatment Liquid>

The pigment ink, the first treatment liquid, and the second treatment liquid can be prepared by any method so as to contain each of the components described so far. For example, the pigment ink can be produced through a step of mixing the above-described pigment, water, a suitable dispersant, and the like.

### [Treatment Liquid for Inkjet Textile Printing and Ink Set for Inkjet Textile Printing]

Next, one embodiment of the treatment liquid for inkjet textile printing of the present invention will be described. The treatment liquid for inkjet textile printing of the present embodiment is a treatment liquid for inkjet textile printing as a second treatment liquid used in inkjet textile printing in which a pigment ink, a first treatment liquid, and a second treatment liquid are applied with an inkjet head. That is, the treatment liquid for inkjet textile printing of the embodiment is configured in the same manner as the second treatment liquid used in the textile printing method of the embodiment described above. Furthermore, one embodiment of the ink set for inkjet textile printing according to the present invention is an ink set for inkjet textile printing including a pigment ink, a first treatment liquid, and a second treatment liquid, wherein the second treatment liquid is the above-described treatment liquid for inkjet textile printing according to the present embodiment. According to such a treatment liquid for inkjet textile printing and an ink set for inkjet textile printing, an image having good wet friction robustness can be formed on a textile without impairing the texture.

### Examples

Hereinafter, the present invention will be specifically described with reference to Examples, but the present invention is not limited thereto. Note that in the following Examples, operations were performed at room temperature (25° C.) unless otherwise specified. In addition, unless otherwise specified, “%,” “ppm,” and “part (s)” mean “% by mass,” “ppm by mass,” and “part (s) by mass,” respectively. In the following Examples, a dispersion refers to a substance in which resin particles, a pigment, and the like are dispersed in a dispersant.

[Preparation of First Treatment Liquid] <Preparation of First Treatment Liquid a-1>

The following components were mixed in an amount of 100% by mass to prepare a first treatment liquid a-1. MPT-60 (flocculant, manufactured by Mitsubishi Pencil Co., Ltd): 4 parts by mass Glycerin: 10 parts by mass Propyleneglycol: 30 parts by mass Proxel GXL (S) (preservative): 0.05 parts by mass Olfine E1010 (surface active agent, manufactured by Nissin Chemical Industry Co., Ltd): 0.1 parts by mass ion exchange water: 55.85 parts by mass.

### <Preparation of First Treatment Liquids A-2 and A-3>

First treatment liquids A-2 and A-3 were prepared in the same manner except that the type and content of the flocculant were changed as listed in Table 1, and the amount of ion-exchanged water was adjusted so that the total amount was 100 parts by mass.

The compositions of the first treatment liquids A-1 to A-3 are listed in Table 1.

TABLE I

| FIRST | | | |
|---|---|---|---|
| TREATMENT | | PARTS | |
| LIQUID | FLOCCULANT | BY MASS | REMARKS |
| A - 1 | MPT - 60 | 4 | CATIONIC RESIN |
| A - 2 | LACTIC ACID | 4 | ORGANIC ACID |
| A - 3 | MAGNESIUM | 4 | POLYVALENT |
| | NITRATE | | METAL SALT |

MPT-60: Alkylamine -epichlorohydrin adduct quaternary salt manufactured by Mitsubishi Pencil Co., Ltd

### [Preparation of Second Treatment Liquid](Synthesis of Resin Dispersion Q-1)

A separable flask equipped with a stirrer, a temperature sensors, a condenser tube, and an argon gas introduction device was charged with an active agent liquid in which 2.52 g of an anionic active agent and 0.58 g of sodium carbonate had been dissolved in 553 g of ion-exchanged H2O in advance. As the anionic surfactant, sodium dodecylbenzenesulfonate: SDS was used. Thereafter, the internal temperature of the separable flask was raised to 80° C. while stirring was carried out at a stirring speed of 330 rpm under an argon gas flow. On the other hand, separately, N-butyl acrylate (BA) 162 g, methyl methacrylate (MMA) 54 g, diacetone acrylamide (DAAM) 12 g, and methacrylic acid (MAA) 12 g were dissolved to prepare a monomer solution.

Next, a polymerization initiator (potassium persulfate: KPS) 0.16 g was dissolved in ion-exchanged H2O 3.06 g to prepare a soln., which was then introduced into the soln. (activator soln) heated to 80° C. Next, the prepared monomer solution was added dropwise to this solution over 60 minute and stirred to prepare a dispersion of resin particles.

Furthermore, after the completion of the dropwise addition of the monomer solution, the mixture was heated and stirred for 120 minutes. Thereafter, a solution obtained by dissolving 0.16 g of a polymerization initiator (potassium persulfate: KPS) in 3.06 g of ion-exchanged water was further added thereto, and the mixture was stirred for 60 minutes. Thereafter, the mixture was cooled to 40° C. to obtain a dispersion of resin particles (resin dispersion Q-1). The resin dispersion Q-1 had a resin concentration of 20% by mass.

### (Resin Dispersions Q-2 to Q-7)

Table 2 shows the product names of the resin dispersions Q-2 to Q-7 and the film elongation of the resin dispersions Q-1 to Q-7. The film elongation is a value measured by the following method. First, each of the resin dispersions Q-1 to Q-7 was applied onto a polytetrafluoroethylene sheet so that the film thickness after drying was 500 μm. Thereafter, each of the applied resin dispersions Q-1 to Q-7 was dried at 23° C. for 15 hours, further dried at 80° C. for 6 hours and at 120° C. for 20 minutes, and then peeled from the sheet to produce a resin film. Using a Tensilon universal tester “RTC-1225A” (manufactured by Orientec Co., Ltd), the obtained polymer film was stretched at a measurement temperature of 20° C. and a measurement speed of 200 mm/min, and the stretching length until the polymer film was broken was measured. The ratio of the measured length to the original length of the resin film, expressed as a percentage, was defined as the film elongation (%) of the first resin particles.

TABLE II

| RESIN | | FILM |
|---|---|---|
| DISPERSION | PRODUCT NAME | ELONGATION (%) |
| Q - 1 | SYNTHETIC PRODUCT | 700 |
| Q - 2 | SUPERFLEX 460 | 750 |
| Q - 3 | IMPRANIL DLP-R | 1550 |
| Q - 4 | IMPRANIL DLH | 650 |
| Q - 5 | TAKELAC W-6061 | 1050 |
| Q - 6 | SUPERFLEX 420 | 290 |
| Q - 7 | TAKELAC W-6010 | 380 |

SUPERFLEX 460: Impranil DLP-R: manufactured by Dai-ichi Kogyo Seiyaku Co., Ltd
Implanyl DLH: manufactured by Sumika Covestro Urethane Co., Ltd
Takelac W-6061: manufactured by Sumika Covestrourethane Co., Ltd
Superflex 420 manufactured by Mitsui Chemicals, Inc.:
Takelac W-6010: manufactured by Dai-ichi Kogyo Seiyaku Co., Ltd Mitsui Chemicals, Inc

### <Preparation of Second Treatment Liquid B-1>

The following components were mixed in an amount of 100% by mass to prepare a first treatment liquid B-1. resin dispersion Q-1:10 parts by mass Shinine E-370 (manufactured by Nissin Chemical Industry Co., Ltd., a silicone acrylic resin): 0.8 parts by mass Glycerin: 10 parts by mass Propyleneglycol: 20 parts by mass Proxel GXL (S) (preservative): 0.05 parts by mass Olfine E1010 (manufactured by Nissin Chemical Industry Co., Ltd., a surface active agent): 0.1 parts by mass ion exchanged water: 55.85 parts by mass.

### <Preparation of Second Treatment Liquids B-2 to B-6>

second treatment liquids B-2 to B-12 were prepared in the same manner as the second treatment liquid B-1 except that the types and parts by mass of the resin dispersion and the silicone acrylic resin were changed as listed in Table 3, and the amount of the ion-exchanged water was adjusted such that the total amount became 100 parts by mass.

The compositions of the second treatment liquids B-1 to B-12 are shown in Table 3.

TABLE III

| SECOND | RESIN DISPERSION | | | SILICONE ACRYLIC RESIN | |
|---|---|---|---|---|---|
| TREATMENT | RESIN DISPERSION | FILM | PARTS BY | | PARTS BY |
| LIQUID | TYPE | ELONGATION | MASS | RESIN TYPE | MASS |
| B - 1 | SYNTHESIS PRODUCT | 700 | 10 | CHALINE E-370 | 1.0 |
| | OF Q-1 | | | | |
| B - 2 | SUPERFLEX 460 | 750 | 10 | CHALINE E-370 | 1.0 |
| B - 3 | IMPRANIL DLP-R | 1550 | 10 | CHALINE E-370 | 0.5 |
| B - 4 | IMPRANIL DLH | 650 | 10 | GHALINE E-370 | 1.0 |
| B - 5 | TAKELAC W-6061 | 1050 | 10 | CHALINE E-370 | 0.5 |
| B - 6 | SUPERFLEX 420 | 290 | 10 | CHALINE E-370 | 1.0 |
| B - 7 | TAKELAC W-6010 | 380 | 10 | CHALINE E-370 | 1.0 |
| B - 8 | SYNTHESIS PRODUCT | 700 | 10 | CHALINE E-790 | 1.0 |
| | OF Q-1 | | | | |
| B - 9 | SUPERFLEX 460 | 750 | 10 | CHALINE E-790 | 1.0 |
| B - 10 | SUPERFLEX 460 | 750 | 10 | CHALINE E-370 | 0.5 |
| B - 11 | SUPERFLEX 460 | 750 | 10 | — | 0.0 |
| B - 12 | — | — | 0.0 | CHALINE E-370 | 1.0 |

### [Preparation of Pigment Ink](Preparation of Block Copolymer P-1)

In a flask equipped with an argon gas inlet tube and a stirring blade, the following components were charged and reacted at 60° C. for 18 hours. Thus, a prepolymer (hydrophilic block A, weight-average molecular weight (Mw): 6920) was obtained. N-butyl methacrylate: 138.8 g methyl methacrylate 73 5 g methacrylic acid 59 6 g ethyl-2-methyl-2-n-butyltetralinyl-propionate 23 3 g dibutyl diteride 14 3 g 2-2-2-azobisisobutyronitrile 2 6 g methylethyl ketone: 166.1 g acetonitrile 166.1

Hereinafter, N-butyl methacrylate is also referred to as “BMA”. Hereinafter, similarly, methyl methacrylate is also referred to as “MMA”. Methacrylic acid is also referred to as “MAA”. Ethyl-2-methyl-2-n-butyltetralinyl-propionate is also referred to as “BTEE”. dibutyl diteride is also referred to as “DBDT”. 2,2′-azobisisobutyronitrile is also referred to as “AIBN”.

To the above reactant, a mixed solution of benzyl methacrylate (hereinafter referred to as “BzMA”) 233 g, MAA23.3 g, AIBN2.6 g, methylethylketone 98.0 g, acetonitrile 98.0 g, which had been prelimInarily substituted with argon, was added, and the mixture was reacted at 60° C. for 9 hours. Thus, a prepolymer (weight average molecular weight (Mw): 9910) containing the hydrophilic block A and the hydrophobic block B was obtained.

A prelimInarily argon-substituted mixed solution of BMA138.8 g, MMA73.5 g, MAA59.6 g, AIBN1.3 g, methylethyl ketone 61.1 g, and acetonitrile 388.5 g was added thereto, and the mixture was reacted at 60° C. for 23 hours. Thus, a block copolymer P-1 (weight average molecular weight (Mw): 13800, acid value: 100) containing the hydrophilic block A, the hydrophobic block B, and the hydrophilic block A was obtained.

Thereafter, 3.6 kg of methylethyl ketone was added to the reactant, and the mixture was poured into 21 L part of heptanes under stirring. The precipitated polymer was suction-filtered and dried to obtain a block copolymer P-1.

### (Preparation of Random Copolymer P-2)

A random polymer P-2 (weight average molecular weight (Mw): 15500, acid value: 96) having a monomer composition of BMA/BzMA/MMA/MAA=36/30/19/15 was obtained by known radical polymerization.

### <Preparation of Pigment Dispersion Preparation of Pigment Dispersion O-1)

To 20.0 parts by mass of the carbon black pigment, the block copolymer P-1 in an amount of 30% by weight, 20 parts by mass of propyleneglycol, and 5 parts by mass of 1,2-hexanediol were added. Further, ion-exchanged water was added and mixed so as to obtain an aqueous pigment dispersion liquid having a pigment concentration of 20.0%, thereby obtaining a precursor of a pigment dispersion. Hereinafter, propylene glycol is also referred to as “PG”. The 1,2-hexanediol is also referred to as “1,2-HD”.

The precursor of pigment dispersion was subjected to dispersion treatment using a horizontal medium disperser (Labo Starmie Co., Ltd., LMZ015 zirconia beads size: 0.3 mm, manufactured by Ashizawa Finetech Co., Ltd) to prepare a pigment dispersion O-1 having a pigment concentration of 20.0%. The volume-based average particle diameter of the pigment dispersion O-1 was 120 nm. The volume-based average particle size of pigment particles was measured using a particle size distribution analyzer (Zeta Nanosizer 1000HS, manufactured by Malvern Instruments Ltd).

### (Preparation of Pigment Dispersion O-2)

A pigment dispersion O-2 having a pigment concentration of 20.0% was prepared in the same manner as in the preparation of the pigment dispersion O-1 except that the block copolymer P-1 was changed to the random copolymer P-2. The volume-based average particle diameter of the pigment dispersion O-2 was 120 nm.

### (Preparation of Pigment Dispersion O-3)

A pigment dispersion O-3 was prepared in the same manner as in the preparation of the pigment dispersion O-1 described above except that Cabo-Jet 4107K (concentration of pigments: 15% by weight) manufactured by Cabot Corporation was used as the pigment-dispersed liquid.

### <Preparation of Pigment Ink C-1>

The following components were mixed in an amount of 100% by mass to prepare pigment ink C-1. Pigment dispersion O-1:3.5 parts by mass Resin dispersion Q-2:10 parts by mass Shalline E-370 (silicone acrylic resin, manufactured by Nissin Chemical Industry Co., Ltd): 0.5 parts by mass Glycerin: 10 parts by mass Propyleneglycol: 20 parts by mass Proxel GXL (S) (preservative): 0.05 parts by mass Olfine E1010 (surface active agent, manufactured by Nissin Chemical Industry Co., Ltd): 0.1 parts by mass Ion-exchanged H20:55.85 parts by mass

### <Preparation of Pigment Inks C-2 to C-5>

Pigment inks C-2 to C-5 were prepared in the same manner as the pigment ink C-1 except that the type of the pigment dispersion and the parts by mass of the silicone acrylic resin and the crosslinking agent were changed as listed in Table 4, and the amount of the ion-exchanged water was adjusted such that the total amount became 100 parts by mass. In the pigment ink C-5, MECANATE NS-1 produced by Meisei Chemical Works, Ltd. was used as the crosslinking agent.

The compositions of the pigment inks C-1 to C-5 are listed in Table 4.

TABLE IV

| | PIGMENT DISPERSION | | | | | |
|---|---|---|---|---|---|---|
| | RESIN | | SILICONE ACRYLIC RESIN | | CROSSLINKING AGENT | |
| PIGMENT | DISPERSION | PARTS BY | | PARTS BY | | PARTS BY |
| INK | TYPE | MASS | RESIN TYPE | MASS | TYPE | MASS |
| C-1 | O-1 | 3.5 | CHALINE E-370 | 0.5 | — | 0.0 |
| C-2 | O-2 | 3.5 | CHALINE E-370 | 0.5 | — | 0.0 |
| C-3 | O-3 | 3.5 | CHALINE E-370 | 0.5 | — | 0.0 |
| C-4 | O-1 | 3.5 | — | 0.0 | — | 0.0 |
| C-5 | O-2 | 3.5 | CHALINE E-370 | 0.5 | MEIKANATE NS-1 | 1.0 |

### [Image Formation and Evaluation]

Using treatment liquids and pigment inks corresponding to the respective formulations of the first treatment liquid, the pigment ink, and the second treatment liquid listed in Table 5, inkjet textile printing methods of Examples 1 to 10 and Comparative Examples 1 to 4 were performed according to the method for printed image formation described below.

### <Printed Image Formation>

As the textile, cotton satin (100% cotton, product name: 60 cotton satin, manufactured by Okadaya Co., Ltd.) was prepared.

The printing method of the inkjet head in the printing apparatus was a scanning method, and Pro120 manufactured by Konica Minolta, Inc. equipped with an inkjet head KMi024i (manufactured by Konica Minolta, Inc) was used. In the textile printing methods of Examples 1 to 10 and Comparative Examples 1 to 4, the first treatment liquid-dedicated head was filled with first treatment liquids a-1 to a-3 corresponding to the formulations of the first treatment liquid illustrated in Table 5. The pigment ink head was filled with the pigment inks C-1 to C-5 corresponding to the formulations of the pigment ink listed in Table 5. Furthermore, the second treatment liquid-dedicated head was filled with second treatment liquids B-1 to B-12 corresponding to the formulations of the second treatment liquids listed in Table 5. Using the head dedicated to the first treatment liquid, the head for the pigment ink, and the head dedicated to the second treatment liquid as described above, each of the first treatment liquids a-1 to a-3, the pigment inks C-1 to C-5, and the second treatment liquids B-1 to B-12 listed in Table 5 was applied onto the textile by an inkjet method. Thereafter, the applied first treatment liquid, pigment ink, and second treatment liquid were dried to obtain a printed image formed product. The ejection of the first treatment liquid, the pigmented ink, and the second treatment liquid from the inkjet head was performed in each of the main scanning 540 dpi× and the sub-scanning 720 dpi. Note that dpi represents the number of ink droplets (dots) per 2.54 cm. The ejection frequency was set to 22.4 kHz. The image was printed in the order of forward path/return path, and prepared by 2 passes (once return: 2 times of scanning). Then, the image was dried at 150° C. for 3 minutes by a belt-conveying dryer to obtain a 100% solid textile printing image formed product of 200 mm×200 mm. Note that the attaching amounts of the first treatment liquid, the pigmented ink, and the second treatment liquid were 10 g/m², 20 g/m² and 10 g/m², respectively. These attaching amounts were obtained from the ejection amounts of the treatment liquids and the pigment ink.

### <Evaluation of Texture>

Sensory evaluation of the texture of the textile after printing was performed by 5 persons. The texture of the textile was evaluated according to the following criteria based on the number of people who felt the textile after textile printing to be harder than the textile before textile printing. Table 5 shows the evaluation results.

A: The number of persons who felt that the textile after textile printing was harder was 0 to 1. B: The number of persons who felt that the textile after textile printing became harder was 2 to 3. C: The number of persons who felt that the textile after printing was harder was 4. D: The number of persons who felt that the textile after printing was harder was 5.

<Evaluation of wet friction robustness The wet friction robustness of the image formed on the textile was evaluated with a crockmeter (rubbing tester type I) in accordance with the wetting test of JIS L 0849.

Specifically, friction was applied to a 100 mm×100 mm region of the formed image by rubbing the region back and forth 100 times with a white cotton cloth for rubbing under a load of 200 g. The white cotton cloth for rubbing was a white cotton cloth that was wetted with water to approximately 100% wet. After the rubbing, the staining grade was determined by a visual method according to item 10 (determination of color robustness) of JIS L 0801, the color transfer to the white cotton cloth for rubbing was observed, and the wet friction robustness was evaluated according to the following criteria. Table 5 shows the evaluation results. According to the following criteria, A and B were regarded as acceptable. The color change criterion is a criterion based on a gray scale for contamination. For example, “Grade 1” is an evaluation result indicating that the degree of contamination is the greatest.

(evaluation criteria for wet friction robustness) The change in A: color is grade 3 or higher. B: The color change is in the second to third grades (excluding the second and third grades). C: Grade 2 color change. D: The color change is grade 1-2 (not including grade 2).

TABLE V

| | | SECOND TREATMENT LIQUID | | | | | | |
|---|---|---|---|---|---|---|---|---|
| | | | RESIN | | SILICONE | | | |
| | FIRST | | DISPERSION | | ACRYLIC RESIN | | PIGMENT INK | |
| | TREATMENT | | FILM | PARTS | | PARTS | | PIGMENT |
| | LIQUID | | ELONGATION | BY | | BY | | DISPERSION |
| | FORMULA | FORMULA | (%) | MASS | CONTAINED | MASS | FORMULA | TYPE |
| EXAMPLE | A-1 | B-1 | 700 | 10 | YES ^{(NOTE 1)} | 1.0 | C-1 | O-1 |
| 1 | | | | | | | | |
| EXAMPLE | | B-2 | 750 | 10 | YES ^{(NOTE 1)} | 1.0 | C-1 | O-1 |
| 2 | | | | | | | | |
| EXAMPLE | | B-3 | 1550 | 10 | YES ^{(NOTE 1)} | 0.5 | C-1 | O-1 |
| 3 | | | | | | | | |
| EXAMPLE | | B-4 | 650 | 10 | YES ^{(NOTE 1)} | 1.0 | C-4 | O-4 |
| 4 | | | | | | | | |
| EXAMPLE | | B-5 | 1050 | 10 | YES ^{(NOTE 1)} | 0.5 | C-3 | O-3 |
| 5 | | | | | | | | |
| COMPARATIVE | | B-6 | 290 | 10 | YES ^{(NOTE 1)} | 1.0 | C-3 | O-3 |
| EXAMPLE 1 | | | | | | | | |
| COMPARATIVE | | B-7 | 380 | 10 | YES ^{(NOTE 1)} | 1.0 | C-1 | O-1 |
| EXAMPLE 2 | | | | | | | | |
| EXAMPLE | | B-8 | 700 | 10 | YES ^{(NOTE 2)} | 1.0 | C-2 | O-2 |
| 6 | | | | | | | | |
| EXAMPLE | | B-9 | 750 | 10 | YES ^{(NOTE 2)} | 1.0 | C-5 | O-2 |
| 7 | | | | | | | | |
| EXAMPLE | | B-10 | 750 | 10 | YES ^{(NOTE 1)} | 0.5 | C-1 | O-1 |
| 8 | | | | | | | | |
| COMPARATIVE | | B-11 | 750 | 10 | — | 0.0 | C-1 | O-1 |
| EXAMPLE 3 | | | | | | | | |
| COMPARATIVE | | B-12 | — | — | YES ^{(NOTE 1)} | 1.0 | C-1 | O-1 |
| EXAMPLE 4 | | | | | | | | |
| EXAMPLE | A-2 | B-2 | 750 | 10 | YES ^{(NOTE 1)} | 1.0 | C-1 | O-1 |
| 9 | | | | | | | | |
| EXAMPLE | A-3 | B-2 | 750 | 10 | YES ^{(NOTE 1)} | 1.0 | C-1 | O-1 |
| 10 | | | | | | | | |

| | PIGMENT INK | | | | | |
|---|---|---|---|---|---|---|
| | SILICONE | | CROSSLINKING | | | |
| | ACRYLIC RESIN | | AGENT | | EVALUATION | |
| | | PARTS | | PARTS | | WET |
| | | BY | | BY | | FRICTION |
| | CONTAINED | MASS | CONTAINED | MASS | TEXTURE | ROBUSTNESS |
| EXAMPLE | YES ^{(NOTE 1)} | 0.5 | — | 0.0 | A | A |
| 1 | | | | | | |
| EXAMPLE | YES ^{(NOTE 1)} | 0.5 | — | 0.0 | A | A |
| 2 | | | | | | |
| EXAMPLE | YES ^{(NOTE 1)} | 0.5 | — | 0.0 | A | A |
| 3 | | | | | | |
| EXAMPLE | — | — | — | 0.0 | A | B |
| 4 | | | | | | |
| EXAMPLE | YES ^{(NOTE 1)} | 0.5 | — | 0.0 | B | B |
| 5 | | | | | | |
| COMPARATIVE | YES ^{(NOTE 1)} | 0.5 | — | 0.0 | D | C |
| EXAMPLE 1 | | | | | | |
| COMPARATIVE | YES ^{(NOTE 1)} | 0.5 | — | 0.0 | C | C |
| EXAMPLE 2 | | | | | | |
| EXAMPLE | YES ^{(NOTE 1)} | 0.5 | — | 0.0 | B | B |
| 6 | | | | | | |
| EXAMPLE | YES ^{(NOTE 1)} | 0.5 | YES ^{(NOTE 3)} | 1.0 | B | A |
| 7 | | | | | | |
| EXAMPLE | YES ^{(NOTE 1)} | 0.5 | — | 0.0 | A | B |
| 8 | | | | | | |
| COMPARATIVE | YES ^{(NOTE 1)} | 0.5 | — | 0.0 | C | C |
| EXAMPLE 3 | | | | | | |
| COMPARATIVE | YES ^{(NOTE 1)} | 0.5 | — | 0.0 | C | D |
| EXAMPLE 4 | | | | | | |
| EXAMPLE | YES ^{(NOTE 1)} | 0.5 | — | 0.0 | A | B |
| 9 | | | | | | |
| EXAMPLE | YES ^{(NOTE 1)} | 0.5 | — | 0.0 | A | B |
| 10 | | | | | | |

^{(NOTE 1)}:
CHALINE E-370 MANUFACTURED BY NISSIN CHEMICAL INDUSTRY CO., LTD. WAS USED AS SILICONE ACRYLIC RESIN.
^{(NOTE 2)}:
CHALINE E-790 MANUFACTURED BY NISSIN CHEMICAL INDUSTRY CO., LTD. WAS USED AS SILICONE ACRYLIC RESIN.
^{(NOTE 3)}:
MEIKANATE NS-1 MANUFACTURED BY MEISEI CHEMICAL WORKS, LTD. WAS USED AS CROSSLINKING AGENT.

### (Result)

Printed images were formed by the inkjet textile printing method of Examples 1 to 10 using, as the second treatment liquid, the treatment liquid containing the silicone acrylic resin and first resin particles having a film elongation of 600 to 1600%. The printed images formed by the textile printing methods of Examples 1 to 10 as described above exhibited satisfactory results in the evaluations of both the texture and the wet friction robustness.

On the other hand, when the film elongation of the first resin particles contained in the second treatment liquid was less than 600%, as in Comparative Examples 1 and 2, it was confirmed that the texture and the wet friction robustness tended to deteriorate. Furthermore, it was confirmed that in both of the case where the second treatment liquid did not contain a silicone acrylic resin as in Comparative Example 3 and the case where the second treatment liquid contained a silicone acrylic resin but did not contain the specific resin particles as in Comparative Example 4, the texture and the wet friction robustness tended to deteriorate.

According to the embodiment described above, an inkjet textile printing method can be provided that can form an image having satisfactory wet friction robustness on textile without degrading the texture.

According to the embodiment described above, a multi-pass inkjet textile printing method can be provided that can form an image having satisfactory wet friction robustness on a textile without degrading the texture. It is also possible to provide a treatment liquid for inkjet textile printing that can be suitably used for such an inkjet textile printing method, an ink set for inkjet textile printing using the same, and an inkjet textile printing apparatus.

The expression mechanism or action mechanism of the effect of the above-described embodiment is not clear, but it is presumed as follows.

First, the first treatment liquid to be ejected first onto the textile in the forward path of the multi-pass method contains a flocculant. Therefore, by sequentially applying the pigment ink and the second treatment liquid after the applying of the first treatment liquid, resins, pigments, and the like in the pigment ink and the second treatment liquid can be aggregated by the flocculant, effectively suppressing the penetration of the ink into the textile in the Z direction. Therefore, the pigment ink and the second treatment liquid applied to the textile after the applying of the first treatment liquid tend to remain on the surface of the textile. Thus, the textile is less likely to be hard, and the texture can be favorably maintained.

On the other hand, the second treatment liquid that is ejected first onto the textile in the return path of the multi-pass method contains the silicone acrylic resin and first resin particles having a film elongation of 600 to 1600%. Since the first resin particles having a film elongation of 600 to 1600% are relatively soft resin particles, even when the first resin particles penetrate into the textile in the Z direction, the influence on the texture is small, and the texture of the textile can be maintained. In addition, for example, since the silicone acrylic resin assists wetting and spreading in the X direction and the Y direction, it is possible to suppress infiltration in the Z direction. Therefore, the silicone acrylic resin contained in the second treatment liquid also contributes to the maintenance of the texture of the textile. Furthermore, since the first treatment liquid that is finally ejected onto textile on the return path contains a flocculant, wet friction robustness is also maintained by such a first treatment liquid being finally ejected.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-069686 filed on Apr. 23, 2024 is incorporated herein by reference in its entirety.

What is claimed is:

1. An inkjet textile printing method for applying a pigment ink, a first treatment liquid, and a second treatment liquid with an inkjet head, the first treatment liquid containing a flocculant and being for retaining at least one of the pigment ink and the second treatment liquid on a textile surface, the method comprising:
arranging the inkjet head that ejects the first treatment liquid, the inkjet head that ejects the pigment ink, and the inkjet head that ejects the second treatment liquid in a same carriage;
forming an image by a multi-pass method;
in a forward path, after applying of the first treatment liquid, applying the pigment ink and the second treatment liquid in an order of the pigment ink and the second treatment liquid;
in a return path, after applying of the second treatment liquid, applying the pigment ink and the first treatment liquid in an order of the pigment ink and the first treatment liquid,
wherein the second treatment liquid contains a silicone acrylic resin and first resin particles having a film elongation of 600 to 1600%; and
attaching the first treatment liquid, the pigment ink, and the second treatment liquid to a same place in a same scanning in an undried state.

2. The inkjet textile printing method according to claim 1, wherein
the pigment ink contains second resin particles and an aqueous solvent, and
at least one of resins of the first resin particles of the second treatment liquid and the second resin particles of the pigment ink comprises an acrylic resin or a urethane resin.

3. The inkjet textile printing method according to claim 1, wherein the pigment ink contains a silicone acrylic resin.

4. The inkjet textile printing method according to claim 1, wherein the first treatment liquid contains at least one type selected from a group consisting of a compound having a cationic group, a polyvalent metal salt, and an organic acid.

5. The inkjet textile printing method according to claim 4, wherein the compound having the cationic group is a cationic resin.

6. The inkjet textile printing method according to claim 1, wherein
the pigment ink contains a pigment and a block copolymer, and
the block copolymer contains two hydrophilic blocks A located at both ends of a molecule thereof and interacting or reacting with at least the flocculant contained in the first treatment liquid, and a hydrophobic block B located between the two hydrophilic blocks A.

7. The inkjet textile printing method according to claim 6, wherein the block copolymer contains an ABA-type block copolymer composed of the two hydrophilic blocks A and the one hydrophobic block B.

8. The inkjet textile printing method according to claim 1, wherein the pigment ink contains a crosslinking agent.

9. A treatment liquid for inkjet textile printing as a second treatment liquid used in the inkjet textile printing in which a pigment ink, a first treatment liquid, and the second treatment liquid are applied with an inkjet head, wherein
the first treatment liquid contains a flocculant and is for retaining the pigment ink or the second treatment liquid on a textile surface,
the inkjet head that ejects the first treatment liquid, the inkjet head that ejects the pigment ink, and the inkjet head that ejects the second treatment liquid are arranged in a same carriage and are used to form an image by a multi-pass method,
in a forward path, after applying of the first treatment liquid, the pigment ink and the second treatment liquid are applied in an order of the pigment ink and the second treatment liquid,
in a return path, after applying of the second treatment liquid, the pigment ink and the first treatment liquid are applied in an order of the pigment ink and the first treatment liquid,
the second treatment liquid contains a silicone acrylic resin and first resin particles having a film elongation of 600 to 1600%, and
the first treatment liquid, the pigment ink, and the second treatment liquid are attached to a same place in a same scanning in an undried state.

10. An ink set for inkjet textile printing comprising a pigment ink, a first treatment liquid, and a second treatment liquid which is the treatment liquid for the inkjet textile printing according to claim 9.

11. An inkjet textile printing apparatus comprising an inkjet head to apply a pigment ink, a first treatment liquid, and a second treatment liquid, wherein
the first treatment liquid contains a flocculant and is for retaining the pigment ink or the second treatment liquid on a textile surface,
the inkjet head that ejects the first treatment liquid, the inkjet head that ejects the pigment ink, and the inkjet head that ejects the second treatment liquid are arranged in a same carriage,
an image is formed by a multi-pass method,
in a forward path, after applying of the first treatment liquid, the pigment ink and the second treatment liquid are applied in an order of the pigment ink and the second treatment liquid,
in a return path, after applying of the second treatment liquid, the pigment ink and the first treatment liquid are applied in an order of the pigment ink and the first treatment liquid,
the second treatment liquid contains a silicone acrylic resin and first resin particles having a film elongation of 600 to 1600%, and
the first treatment liquid, the pigment ink, and the second treatment liquid are attached to a same place in a same scanning in an undried state.
